(19) United States
(12) Patent Application Publication
(10) Pub. No.: US 2018/0174256 A1
(43) Pub. Date: Jun. 21, 2018

(54) Enrollment Management System and Method

(71) Applicant: Approved Colleges, LLC dba Perdia Education, Monterey, VA (US)

(72) Inventors: Patricia Franz, Palm Beach Gardens, FL (US); Anthony Huffman, Monterey, VA (US)

(73) Assignee: Approved Colleges, LLC dba Perdia Education, Monterey, VA (US)

(21) Appl. No.: 15/841,821

(22) Filed: Dec. 14, 2017

Related U.S. Application Data
(60) Provisional application No. 62/435,102, filed on Dec. 16, 2016.

(51) Int. Cl. G06Q 50/20; G09B 7/02

(52) U.S. Cl. CPC G06Q 50/2053; G09B 7/02

(57) ABSTRACT

A system and process for enrollment management begins with a prospective student, also referred to as a user, and an electronic mobile device. The system is designed to track and analyze data on every point in the enrollment decision making process and facilitate a prospective student's decision making process in the pre-enrollment phase of new student recruitment. The information gathered by the system offers institutions the ability to review potential students user behaviors and make the necessary adjustments to their pre-enrollment approach, garnering a higher level of inquiry to student/user conversion as well as inquiry to degree program start conversion. Correspondingly, the system engages the student/user after they have been accepted to the institution, providing in-depth, integrated activities and communication resources, coupled with behavioral tracking of events, increasing the likelihood of creating a deep symbiotic relationship. Thus, a student is engaged and ready to start. The fear many students have of taking such a big step is reduced. Structurally, the system and method include a central system server as a common hub for the communication and interactions described here combined with technological integration with the institutional servers. This combined technology interface provides key communication and action-related feedback to the users with real time transparency.

This application claims the benefit of U.S. Provisional Application No. 62/435,102, filed Dec. 16, 2016, which is incorporated by reference herein in its entirety.

The present invention relates generally to systems, methods, and the behavioral science of individuals in their decision making process(es) during the pre-enrollment phase of selecting, applying for, and entering a degree program at a post-secondary educational institution. The invention relates to the management of potential new student enrollments into degree and/or certificate programs at these institutions. The invention encompasses student discovery, program evaluation, application for admission, completion of post-acceptance requirements, and the processing for same. In particular, the present invention relates to computer-implemented systems, methods, and behavioral science for acquiring and guiding student behaviors and data as well as importing that data into post-secondary higher education administrative systems.

### BACKGROUND

The classic process(es) for potential student enrollment to collect information about institutions of higher learning and ultimately applying for admission to one or more institutions has been followed by such students for many years. Typically, the process(es) is very manual, time-consuming and repetitive. The Internet facilitates the presentation of information by institutions; however, the methods remain frustrating in their monolithic nature—often discouraging potential students. This frustration may ultimately lead students away from the process altogether. The classic process(es) may also result in students simply becoming fatigued with the minutia and turned off by an institution through the bureaucratic battle. The institutional requirements and procedures are all a little bit different, requiring an interested consumer to expend many hours of frustration for each institution and program of study they desire to research. There is the need for significant human involvement to convey information and application purposes. The end result is an antiquated industry that is ultimately not inviting or helpful.

For example, many higher education institutions rely on the prospect student to be able to fully navigate an institution's website, rely on students making ad hoc phone calls to solicit answers to specific questions, and other student “self-service” methodologies. These other methodologies are formulated for students to gather multiple physical forms and layers of the information needed for a student to make an informed, comprehensive decision. Accordingly, post-secondary institutions may lose the ability to service students effectively, or they garner students who have struggled to gather information effectively to make an informed decision.

Additionally, higher education institutions can typically capture limited information about visitors to their websites. They cannot capture rich, behavioral information about those visits. Most schools are not able to track data points and student activity at very detailed behavioral points in the process. Consequently, there is no specifically identifiable behavioral data or information permitting institutions to service their prospective student population effectively, efficiently and in a mobile modality.

Solicitation of students in the post-secondary education market is an incredibly competitive environment. Students inquire with multiple institutions, yet most schools do not know or follow known best practices when outreaching and advising students during the initial pre-enrollment process(es) (inquiry through day one). Some for-profit, larger institutions create call centers which contain inflated overhead and aggressive enrollment goals to pay for the overhead expenses. This approach tends to override the student's concerns, pushing students through the decision-making process(es) with aggressive sales tactics. These sales tactics are necessary to allow for the institution to reach targeted enrollment goals, which translates to revenue to cover the cost of pre-enrollment services within a call center environment. Other institutions work with “enabler” (third-party) companies; outsourcing all marketing and enrollment management processes. This approach is expensive. Schools forfeit 50-80% of the lifetime tuition (revenue) for each enrolled student. Lastly, most schools try to do the best they can with part-time help and ad hoc processes. This approach leads to poor customer service and uninformed students. These students tend to either fall out prior to application for admission or apply for admission and do not start their program.

### SUMMARY

Hence, it is an object of the present invention to overcome the drawbacks of existing “classic” systems and methods of pre-enrollment recruitment in the post-secondary education market. The invention is facilitated through prospective students' mobile devices. The system and method described herein is able to customize interactions and more efficiently and effectively move a student through their decision-making process(es) in discovery and commitment to enroll into a degree program at a post-secondary educational institution within the United States.

In one example, an interactive decision making system in the field of higher education enrollment comprises a central system server and a user electronic mobile device which are adapted to be operatively connected to each other. The central system server comprises a first memory for receiving and storing program and admission information provided by an institution of higher education, a second memory for assigning and storing an individual user identification and information, a third memory for storing a plurality of subject specific communication messages, and a fourth memory for storing questions to and answers from an individual user. The second memory further comprises a plurality of screening questions to identify user subject specific interests. The central system server also includes a spatial detector for measuring and storing spatial information including the date of use by the user of the central system server, amount of time of that use, and movement of the individual user of the user electronic mobile device on the central system server. The central system server guides the individual user through a process of enrollment at the institution of higher education, and further wherein the step of guiding includes subject specific messages from the third memory is dependent in part on the spatial information measured and stored about the individual user and is also dependent on the subject specific interests of the user saved in the second memory during the enrollment process. The central system server may further comprise a message transmitter for sending subject specific communication messages to the user. The subject specific communication messages may be sent via multiple levels of communication that vary depending on the spatial information stored with respect to the individual user movement on the central server system. Those levels of communication may be selected from the group consisting of notifications, reminders, messaging, emails, inbound call routing, chat services, and form and content display. The subject specific communication messages may include content from an institutional server, third party content and institutional deadlines. The level of communication may depend on the institution of higher learning, type of academic program, and user educational history. The central system server may match user subject specific interests to the higher education institutional server. The institutional server houses student information at a high level, typically post application for admission. The central server system will post student dossier information along with student application for admission in to the institutional server.

In another example, a method for managing information and enrollment in the field of higher education comprising the steps of providing a central system server and a user mobile device which are adapted to be operatively connected to each other. The institutional server comprises program and admission information provided by an institution of higher education. The central system server includes a first memory for receiving and storing program and admission information provided by an institution of higher education, a second memory for assigning and storing an individual user identification and information, a third memory for storing a plurality of subject specific communication messages, and a fourth memory for storing questions to and answers from an individual user. The central system server also includes a spatial detector for measuring and storing spatial information including the date of use by the user of the central system server, amount of time of that use, and movement of the individual user of the user electronic mobile device on the central system server. The method further includes assigning to the user by the central system server a unique user identification, and prompting program and admission screening questions by the central system server to the user to identify user subject specific interests. The method further includes storing answers to the program and admission screening questions by the central system server, detecting the spatial information of the individual user and storing the spatial information associated with the unique user identification, and selecting individual pathways of communication by the central system server to the user based on the stored spatial information of the user and stored answers by the user to the user subject specific interests questions from the central system server, whereby the process of enrollment by a user is customized to the user based on the spatial information and screening question answers of the individual. The central system server may further comprise a message transmitter for sending subject specific communication messages to the user. The subject specific communication messages may be sent via multiple levels of communication that vary depending on the spatial information stored with respect to the individual user movement on the central server system. The levels of communication may be selected from the group consisting of notifications, reminders, messaging, emails, inbound call routing, chat services, and form and content display. The subject specific communication messages may include content from an institutional server, third party content and institutional deadlines. The level of communication may depend on the institution of higher learning, type of academic program, and user educational history. The central system server may match user subject specific interests to the higher education institutional server.

### BRIEF DESCRIPTION OF THE DRAWINGS

FIG. 1 is a flowchart of an example of how a user/client navigates the interactive decision making system described herein.

FIG. 2 is a flowchart that illustrates how the central system server operates to facilitate the method described herein.

FIG. 3 is a flowchart that illustrates examples of the central system server communication methods that may be employed.

FIG. 4 is a flowchart that demonstrates client/user communication methods.

FIG. 5 is a flowchart that illustrates how a user comes to access the interactive decision making system described herein.

FIG. 6 is a flowchart illustrating execution of the interactive decision making system and method described herein.

FIG. 7 is a flowchart that illustrates the real time interactivity of the interactive decision making system when the user is for example a student.

FIG. 8 is a flowchart that illustrates the central system server to IDMA communication structures.

FIG. 9A is a legend that helps guide through the actions in the flowcharts of FIGS. 9B 9F.

FIG. 9B is a workflow chart of an example user for the School and Program, Goals and Motivation and Degree Outcome features of the system and method described herein.

FIGS. 9C and 9C Cont. are the flowchart of an example user for the Admission Qualification feature of the method and system herein.

FIGS. 9D and 9D Cont. 1 and 2 are work flowcharts of an example of the Student Type feature of the method and system herein.

FIGS. 9E and 9E Cont. 1-4 are work flowcharts of an example user for the Application for Admission feature of the system and method herein.

FIGS. 9 and 9F Cont. are workflow charts of an example user of the Post Admission student engagement feature of the system and method herein.

FIGS. 10 and 10 Cont. 1 illustrate the top line organization of the process flow within the IDMA.

FIG. 11 illustrates a student step-by-step progression in the method and system described herein.

### DETAILED DESCRIPTION

The system and process described herein begin with a prospective student, also referred to as a user, electronic mobile device. These devices include mobile telephones, tablets, laptops and other electronic devices that are embraced by users. And while mobile devices are predominant, the system and method may also be used with older and more conventional, stationary electronic devices such as personal computers.

The system is designed to track and analyze data on every point in the student/user's decision making process as they are selecting an institution and degree program in the post-secondary educational arena. This offers institutions the ability to review prospective student user behaviors and make the necessary adjustments to approach, services, and outreach to garner a higher level of inquiry to applicant/user conversion as well as applicant to start conversion. Also, the system engages the student/user after they have been accepted for admission to their program of interest, providing activities and communication resources to students so they have a higher likelihood of creating a relationship with the institution at a deeper level. Thus, a student is engaged and ready to start their initial classes. This engagement increases the likelihood of an accepted student starting their degree program by reducing the anxiety and fear inherent in taking such a big step and commitment.

Structurally, the system and method include a central system server as a common hub for the communication and interactions described here and provide individual institution program and admission information. One or more institutions of higher education are also involved in the system and method in that data point for application for admission is uploaded and directly integrated from the central server into the institutional server and in a feedback look, the institutional server will feed acceptance and post admission data back into the central server.

The central system server includes at least four different, fundamental databases or memories storing relevant information. The first memory is a database that stores programmatic data for the degree programs offered at the institutional level along with institutional requirements for admission into said degree programs.

The second central server memory assigns and stores individual user identification and information. This information in the second memory includes a series of screening questions to discover a user's subject specific interests. The information gleaned from these screening questions inform and guide the entire use of the system by a particular individual user.

The central system server third memory contains a plurality of subject specific communication messages. In this way, interactions with a user are individualized with individual users. A user receives relevant information and guidance only. The messages may also include customized formats and styles that conform to and are determined to be helpful to a user.

A fourth memory in the central system server stores the questions and answers of each individual user of the system. In this way, the total interaction of a user is saved and then used to select and choose forward pathways of communication and methods of communication. The interactions are never lost. Instead, they are saved to maximize the quality and substance of the communication with the user.

The central system server also includes a spatial detector. The spatial detector measures and stores spatial information that includes the date of use of the central system server by a user, the amount of time of that use, and the movement of the individual user of a user electronic device on the central system server. As will be explained, there is important information about a user that is gathered and processed by the system. A user can be prompted to receive subject specific help. The user can be sent reminders when there are gaps in usage of the system.

The essential theme of the system is the smart guidance and assistance that is provided to a user to help them through the enrollment process. Individual attention is focused on offering steps and pivotal information, based on behavioral science of a prospective student/user's decision making process in this event. The information is provided in a way that improves the efficiency and productivity of the enrollment process.

The system described herein may alternatively be referred to as an Interactive Decision Making Apparatus (IDMA) that is enabled to govern students/users through their decision making process(s). The function of IDMA is to enable end process decisions through information transfer, user engagement, and organically structured pathways. For purposes of the IDMA and this invention, the connotation of organic is defined as pathways specific to the individual user with an integration of known behavioral steps in the decision making process(s). IDMA is built upon three integrated foundations to enable the capture of space-time data in the visualization and analyses of multiple dimensions: spatial scrutiny, pathway structures, and adaptive communication services.

Traditional spatial analysis, within the conventional student interactivity and decision making archetype, has focused on a single universe, broad-based characterization of users. Existing methodologies employ human telephonic associations and mass email communication, at the macro level. Further, current macro-level data capture and analysis is often intertwined with human theoretical intervention. These methodologies are lacking in robust temporal dimension. IDMA uncovers multiple layers of universes, resulting in enhanced, qualitative and quantitative observable decision pathways.

### Spatial Scrutiny:

The execution of base coding conventions prompt IDMA to capture packet time references via precise system date and timestamps. This detector component of the system collects packet time stamps that consist of the date (for instance in days since Jan. 1, 1950) and the time of day (in nanoseconds since midnight). This information is stored with a fixed precision (e.g. microseconds) on a user-by-user basis, for each movement a user takes within the system/apparatus. A movement is determined by individual interaction or association, in any form, within the IDMA. Interaction or association is defined as the presentation of queries by the IDMA, the display of user interface screens, and/or system sections navigated to, by each user within the apparatus. Thus, the detector identifies and saves the time aspects of a user in the system and the subject specific behavior over that time sequence. With the capturing and recording of the foregoing spatial data, IDMA cross-references four dimensional differences against multiple layers of pre-determined events, triggers, and communication methodologies. This cross-reference feeds to pathway structures.

### Pathway Structures:

User methodologies of the system (IDMA) are formed by enforcing unique pre-determined conduits, terminating at a decision. These conduits represent timelines, logical steps, and required methods of operations. Meaning, structural components within each conduit are formatted and assembled with process and program requirements as their principal substance. Variances in conduits are presented through the IDMA based on user intervention, spatial scrutiny, program requirements, or user responses. Multiple pathway structures are adapted, each constructed with four primary dimensional differentiators: type of institution, type of program, type of user, and previous educational history. Pathway channels are distinct and organic in nature as they are captured at the micro level, based on human behaviors associated with the interactions and response values.

### Communication Services:

Centered on spatial scrutiny and combinations of relevant pathway structures, triggers are executed by the system described herein—IDMA. IDMA triggers are event-driven, specialized procedures that are pre-programmed to serve multi-channel communications. Execution of communication occurs through system notification, system alerts, reminders, internal system and external messaging, email, inbound call routing, chat services, form or content display. Individual types of communication are determined based on individual user behavior or on demographic tendencies. The types of communication may evolve and change over time with respect to a specific system user. Content of communication is user-specific, created from deliberate input. Input is derived from third-party content, institutional deadlines, and research-driven information.

### Market Specificity:

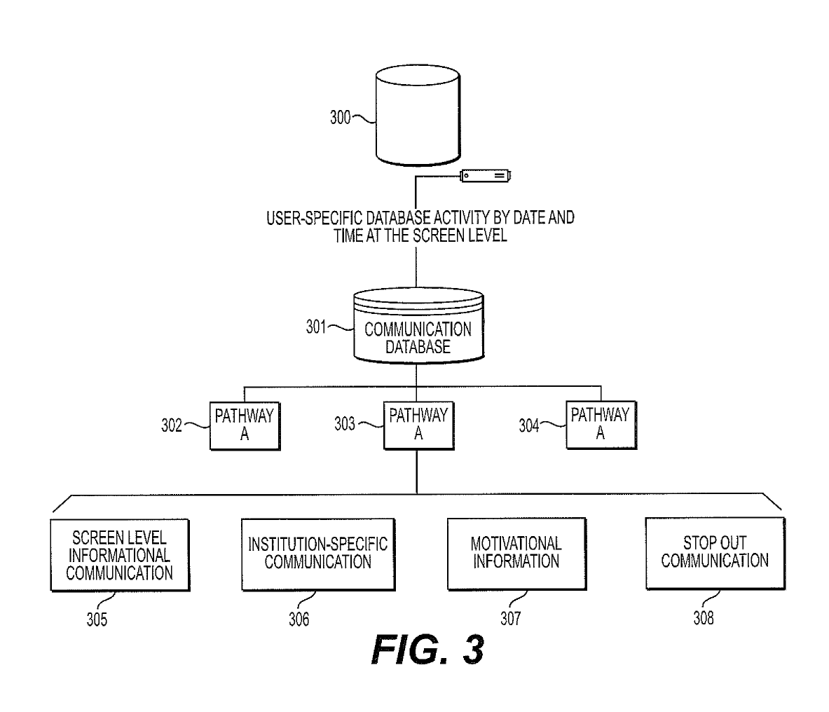

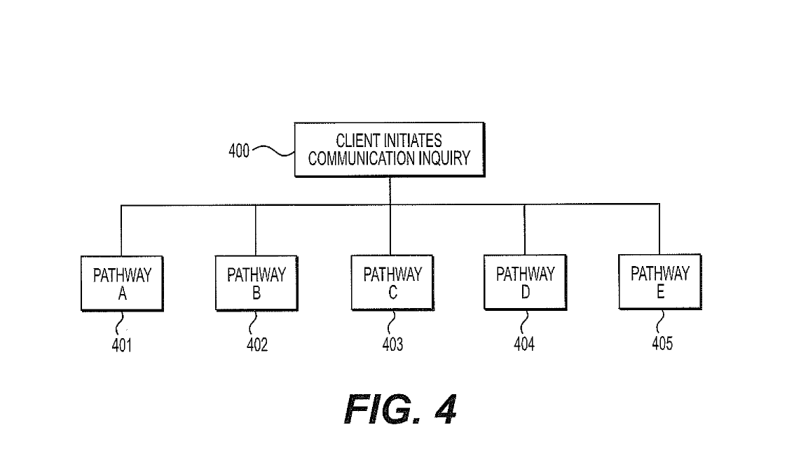

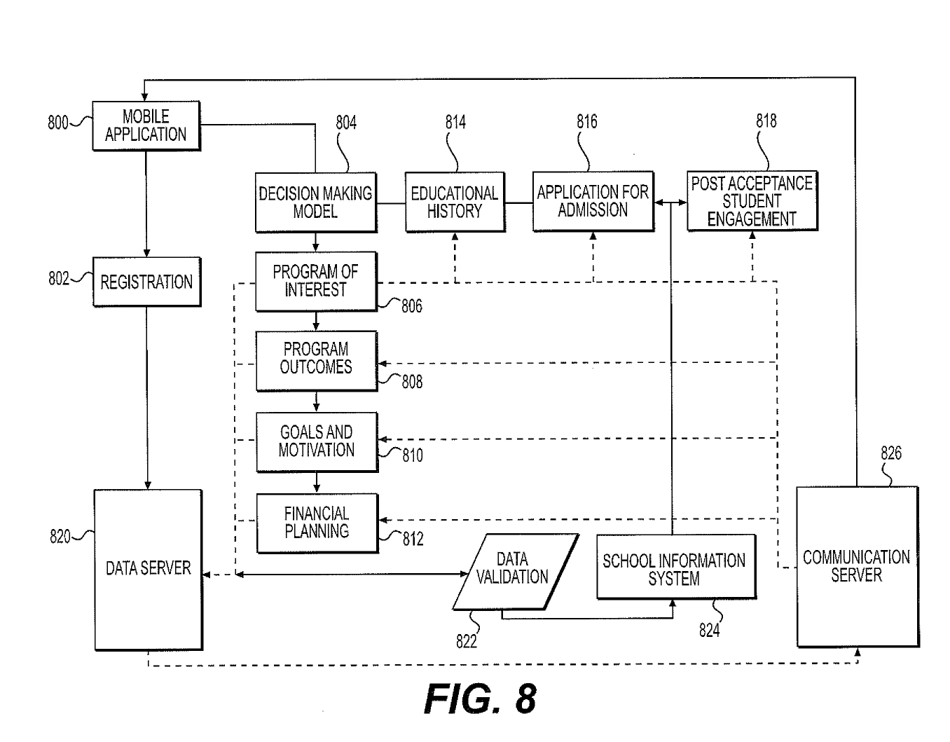

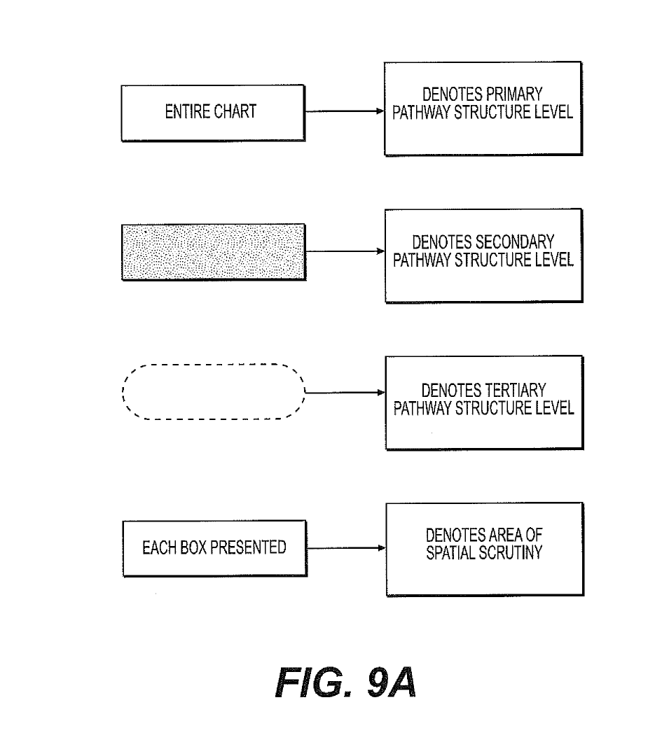

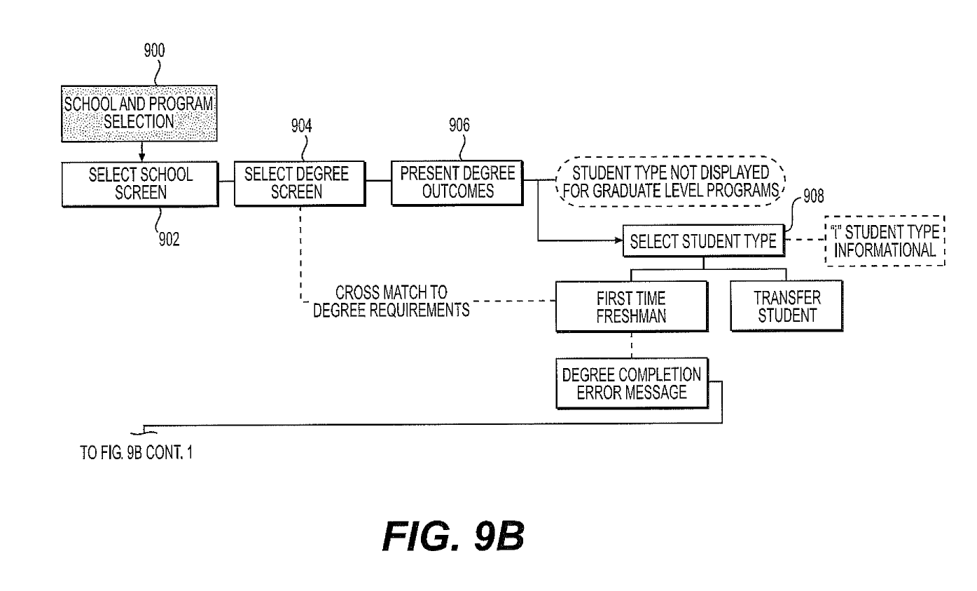

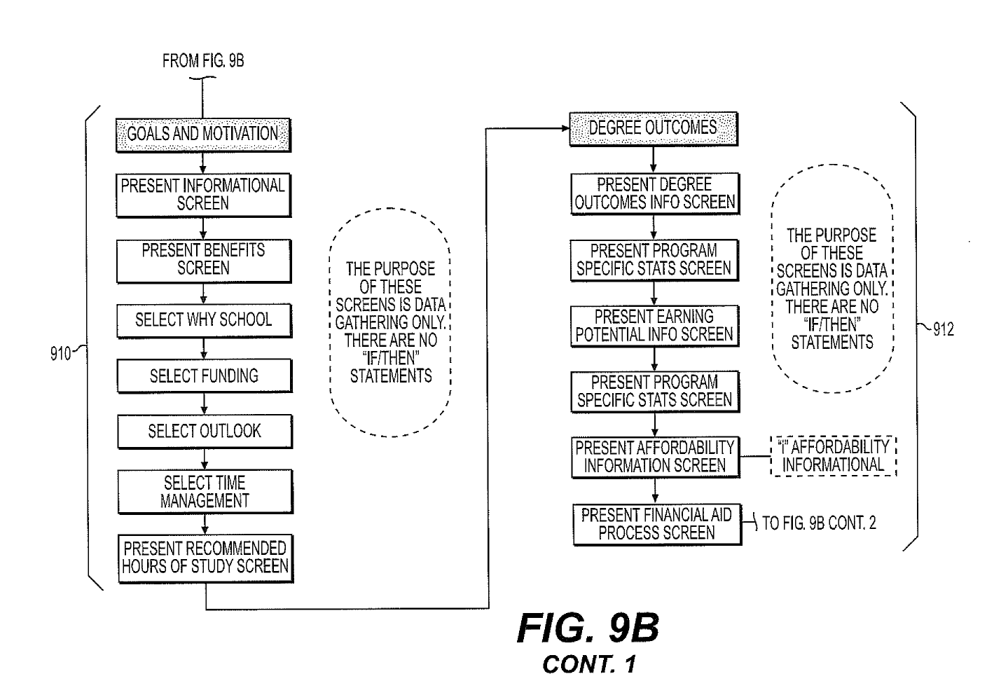

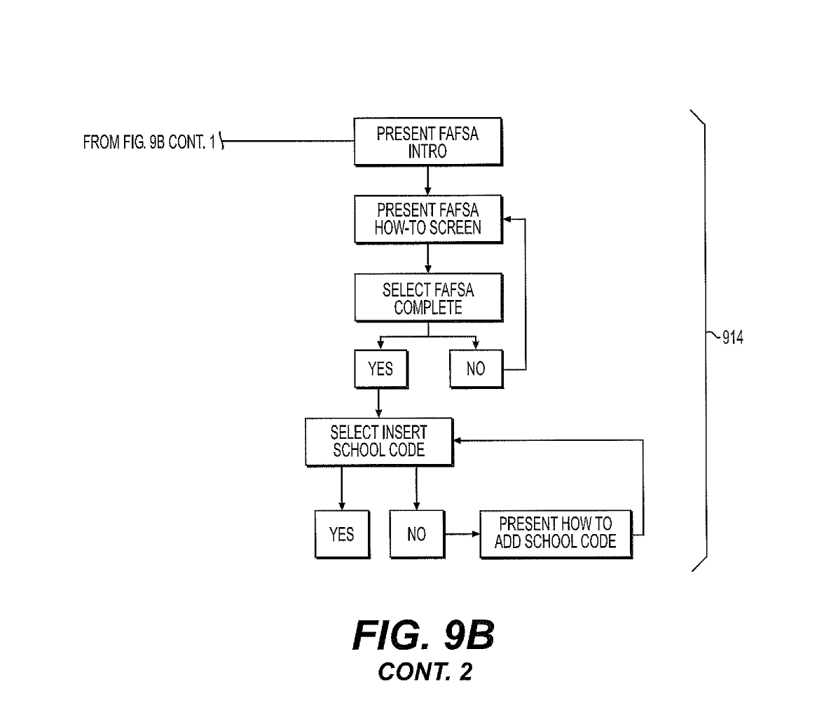

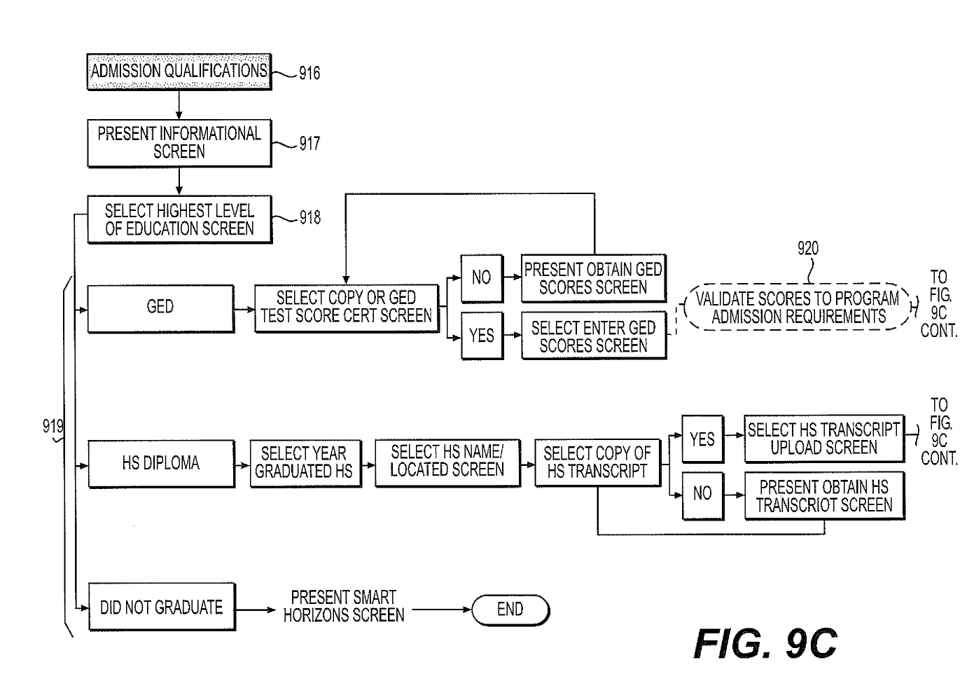

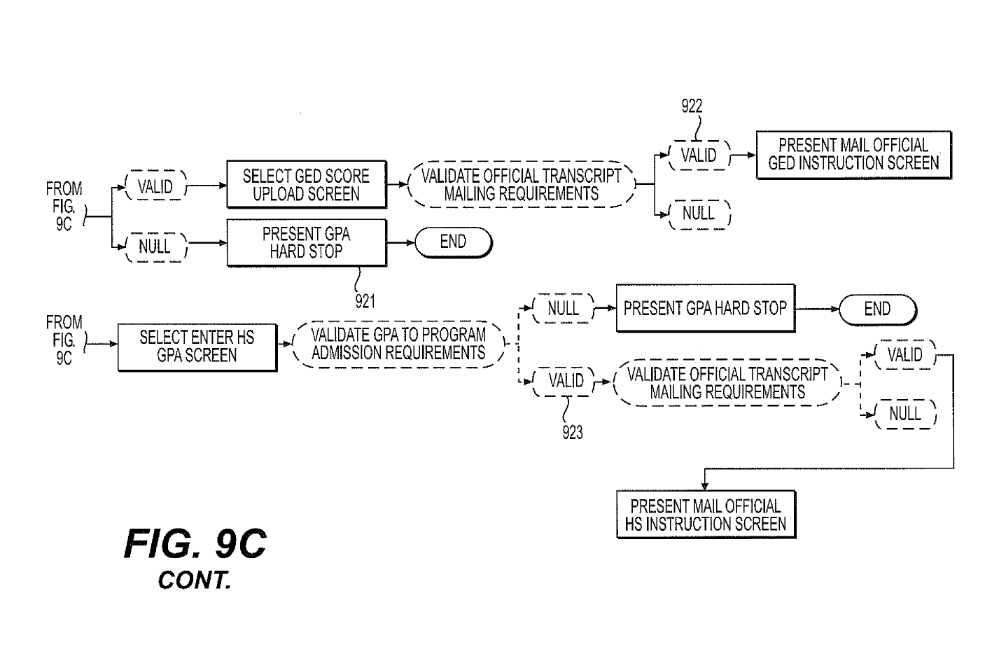

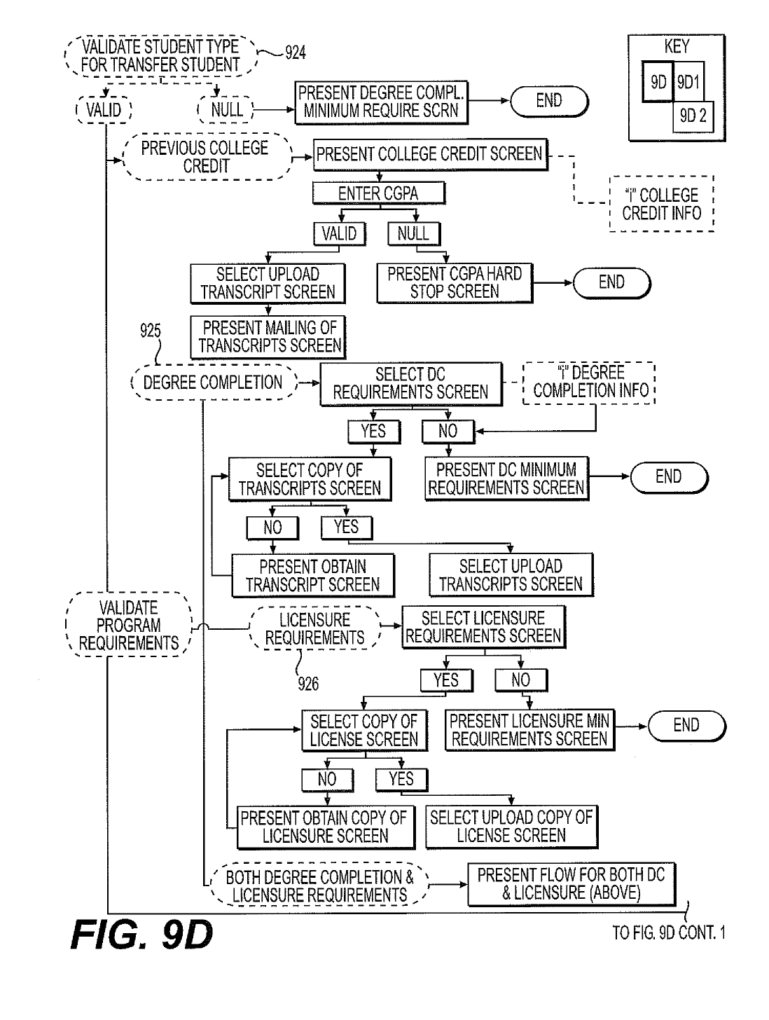

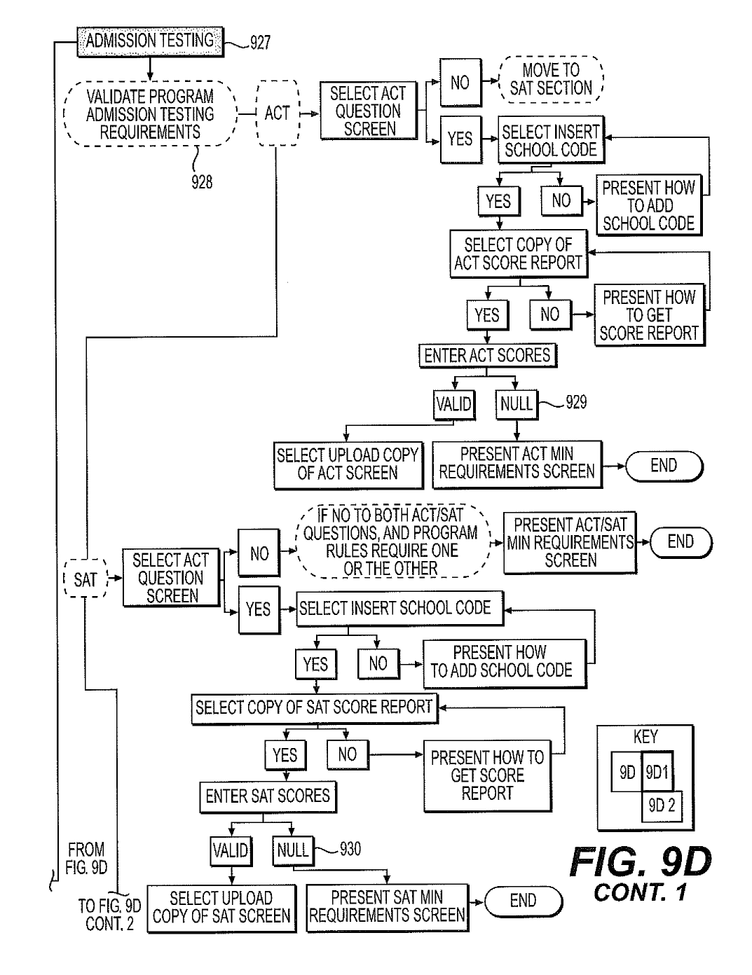

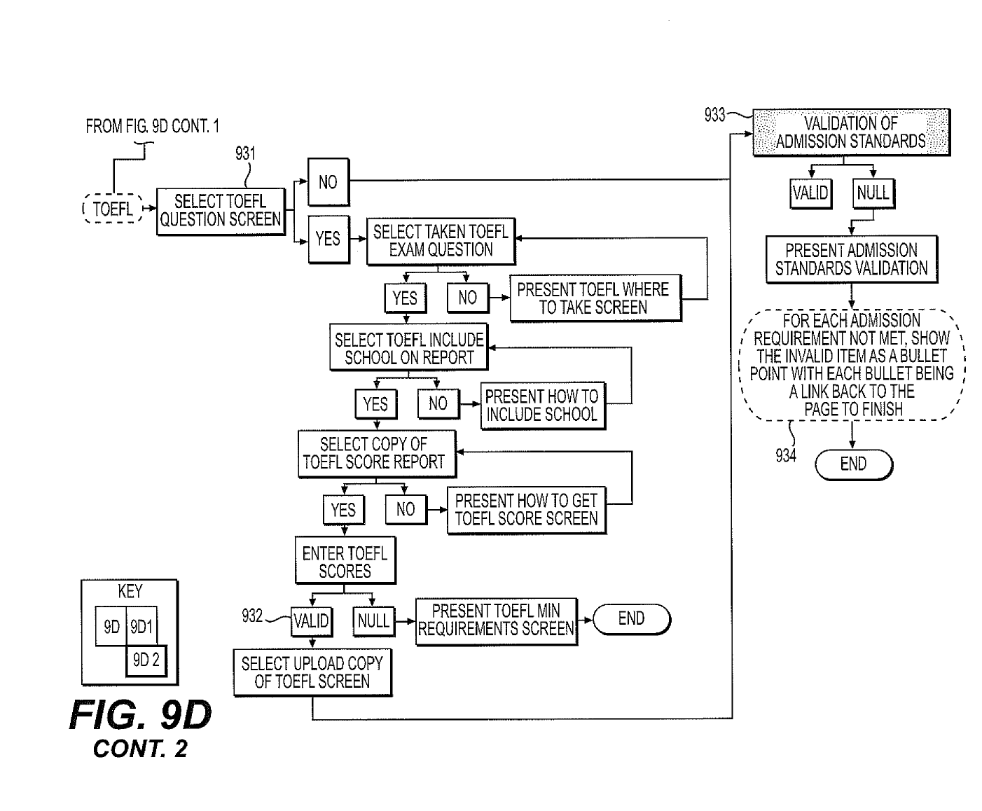

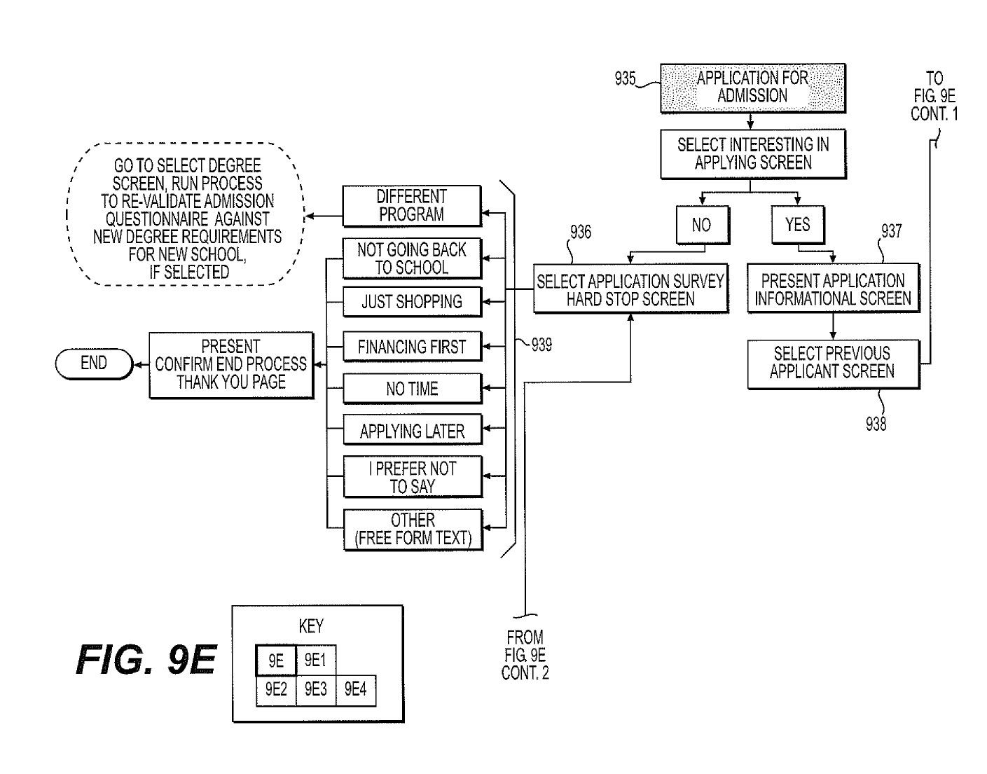

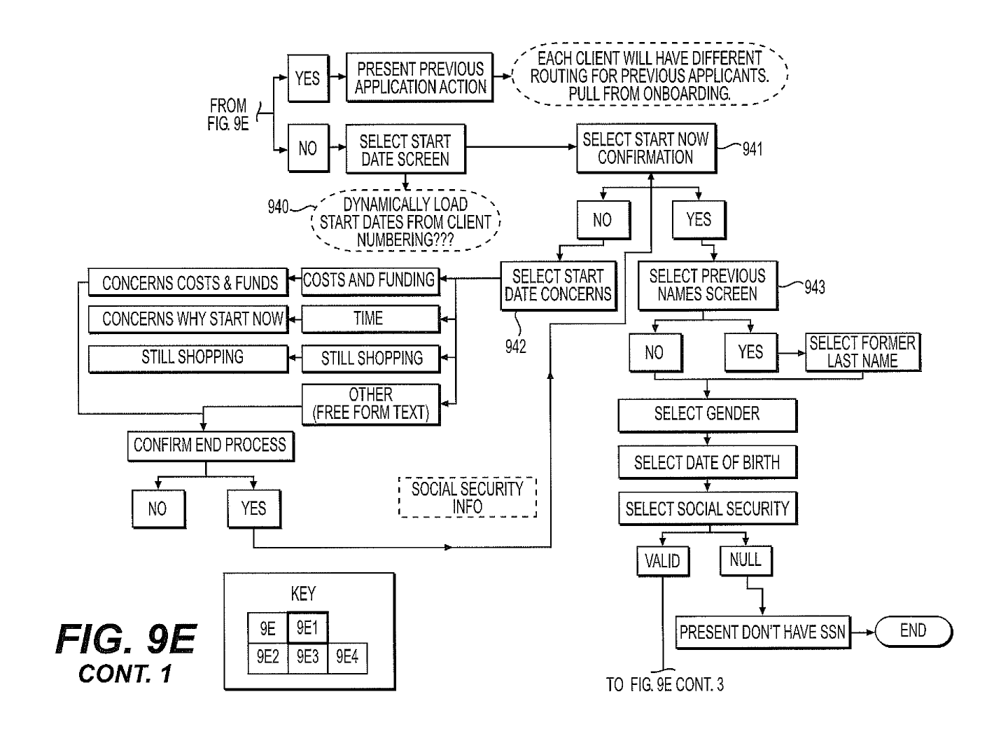

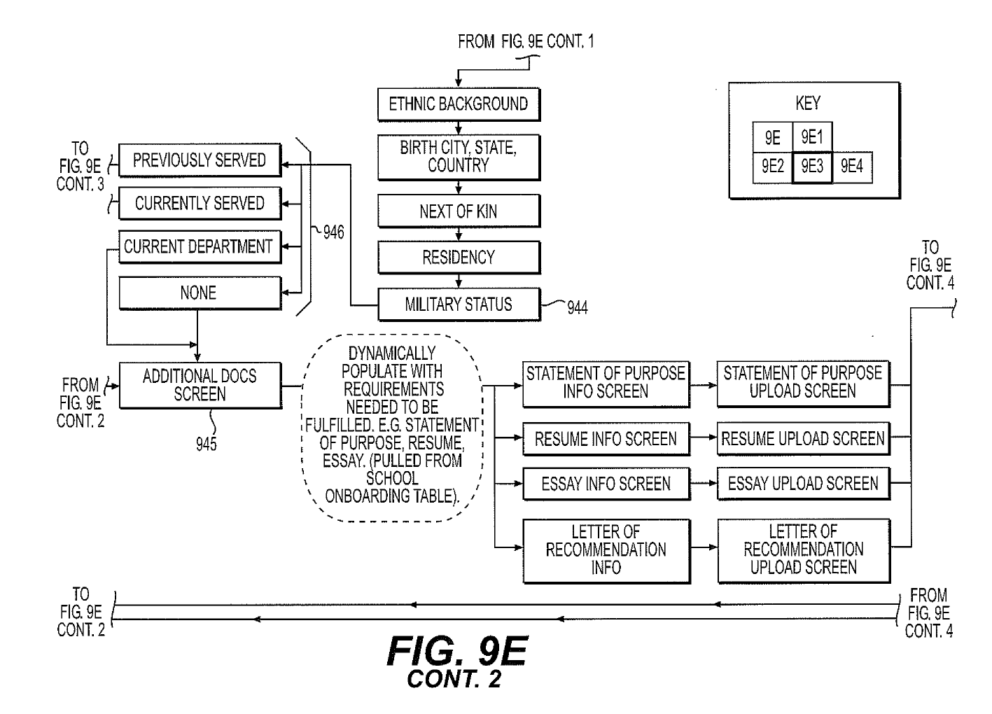

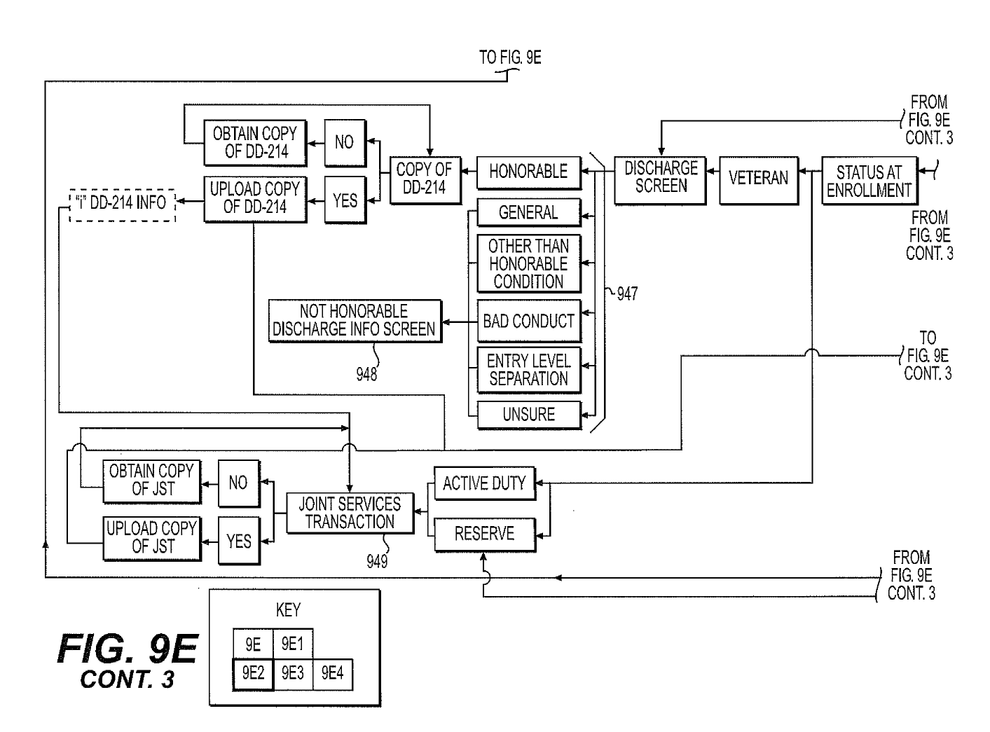

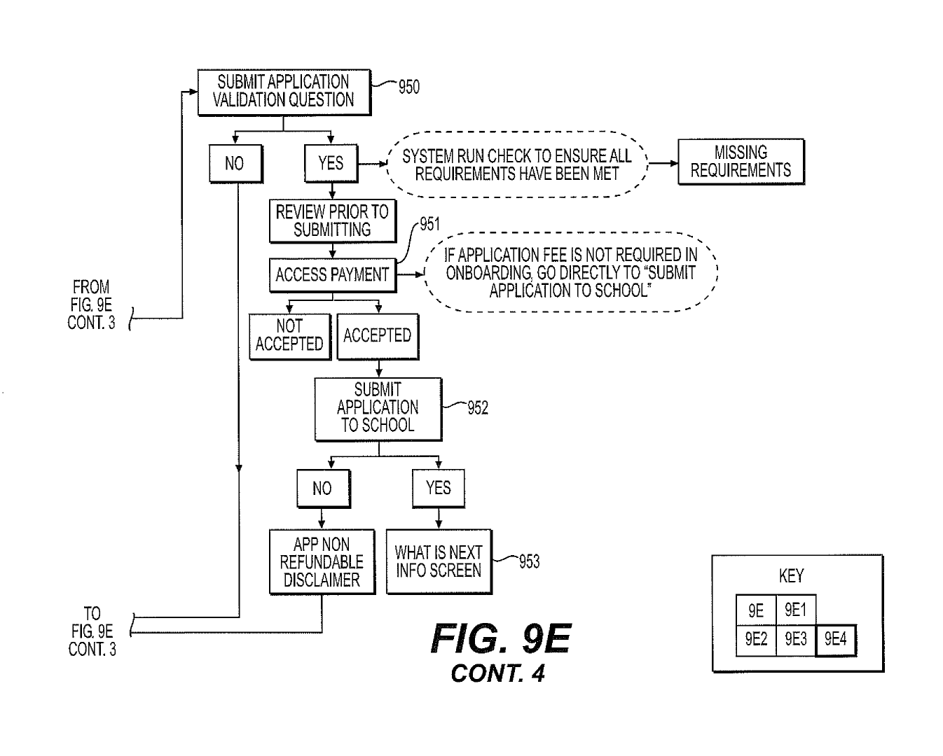

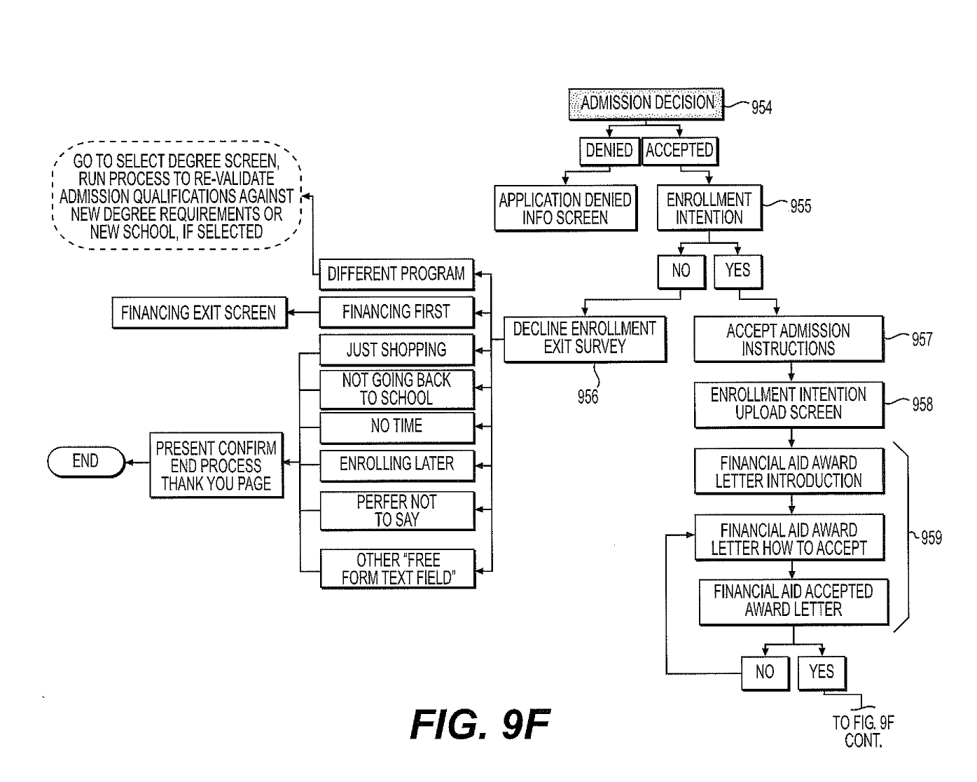

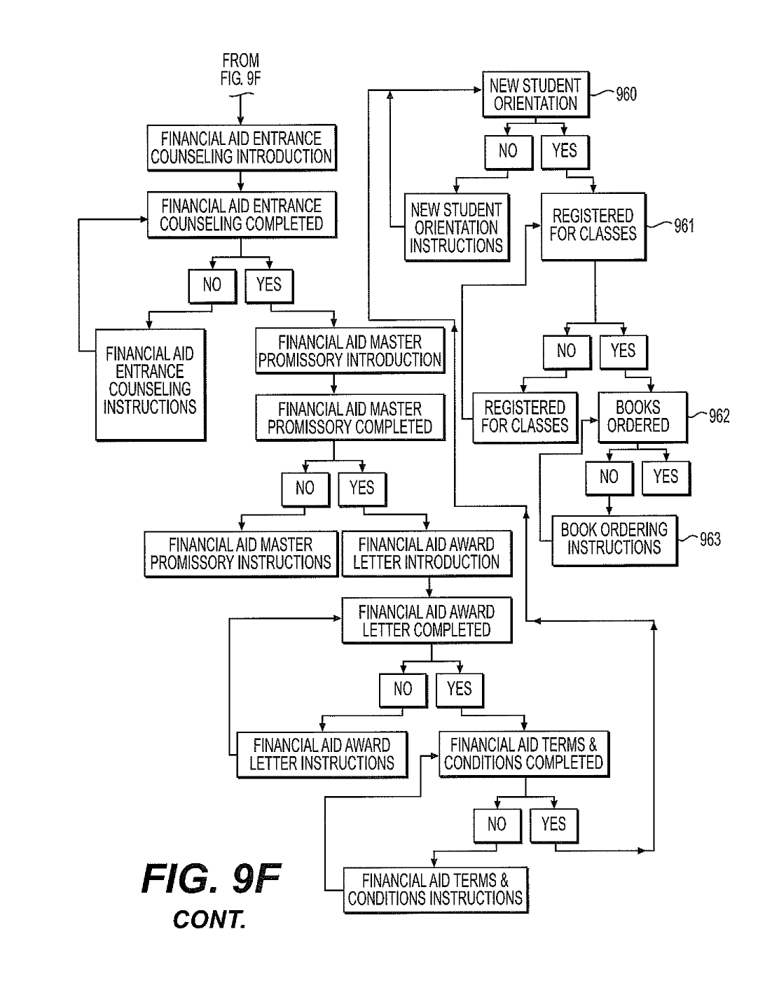

The three integrated foundations of spatial scrutiny, pathway structures, and adaptive communication services are subsequently applied to multiple generic uses governing the decision making process of individuals depicting various levels of previous education in both the secondary and post-secondary education arena. Previous education levels of schooling dynamically feed to pre-determined program and course identifiers. Program and course identifiers relate to accredited and non-accredited programs providing credit and non-credit baring credentials on one or all of the undergraduate, graduate, and continuing education platforms. FIGS. 9B-F along with accompanying legend (FIG. 9A) identifies how a credit bearing, undergraduate example is driven by the system and method described herein. That is, the cohesive integration of spatial scrutiny, pathway structures, and communication services drive prospective student decision making within the post-secondary, higher education marketplace. FIGS. 3 and 4 depict the communication integration to this example flow both at the server level and at the client level. The depicted communication is rolled up to reflect the pathway structures on FIG. 8.

### Method Performed at the Client Level:

The enrollment management system transforms a mobile computing unit into an interactive decision making apparatus for prospective students seeking to enter the post-secondary education and continuing education marketplace. The system is an individualized structure constructed of filters and algorithms custom-built to delineate unique student characteristics coupled with integrated behavioral research. The system, therefore, presents potential educational paths, interactively. The flow and presentation combined with algorithmic pathways enhance the user's decision making ability.

The system, when added to existing computer-related technology, allows for a single user to be guided through the process of selecting and entering post-secondary educational institutions. Without this system, existing computing/mobile components would not, and could not, perform the task. The present system, therefore, is an improvement to the functioning of existing computer-related technology, or human-related processes. To date, a computer or mobile computing unit cannot in and of itself analyze behaviors of individuals, it cannot develop solutions for prospective students, and it does not provide individual interactivity to drive decisions. Similarly, today, human-related processes cannot imitate or replicate at the detailed level of the IDMA, nor with the consistency and effectiveness.

### Method Performed at the Server Level:

The system and method are built upon logical structures and processes that are organic in nature. To reiterate from above, for purposes of this invention, the connotation of organic is defined as pathways specific to the individual user with an integration of known behavioral steps in the decision making process(s). Existing technologies, through integration with this system, will be able to define and evaluate human characteristics, interpret behaviors associated with those characteristics, logically analyze and provide steps of evaluation to the users and drive a decision path. The logical structures have been designed to utilize the hardware within the mobile computing realm and transform this hardware into a prospective decision-making machine. The enrollment management virtual system is pyramidal to the human function of enrollment management and student counseling at the highest level. The system does not replace or replicate the human function, it is additive to and demonstrated in a way not humanly possible. The decision making apparatus instills consistency of information 100% of the time, analyzes and presents data to enhance decisions and outcomes.

A software application transforms a user's mobile devices into a facilitated decision-making archetype for higher education institutions and promote behavioral data analysis for institutions to enhance current operational processes. The platform examines a student's/user's decision pathway to identify a problem or opportunity, gather information, analyze situations, develop options and evaluate alternatives. The system is a decision making model, data processing and communication system designed to facilitate student enrollments as well as monitor and record information relating to a student's entry into a post-secondary degree program. The software validates information in real-time, notifying users of their propensity of acceptance into a program. In particular, the system generates questions and elicits responses through a data model to promote decisions on educational pathways. Modeled from experiential knowledge, the decision pathway is unique and distinctive. Enhancements to the decision pathway are made by gathering data from external sources such as labor websites, academic catalogues, and other resources. Student behaviors and responses from within the system are captured for analysis to help users more effectively manage their decision to enter a degree program.

The system and method will now be demonstrated with the attached drawings that provide visualization of the methods described herein. The drawings are substantive in that they provide full, written explanation of the various methods that might be available. The following description is redundant of the information set forth in the drawings themselves.

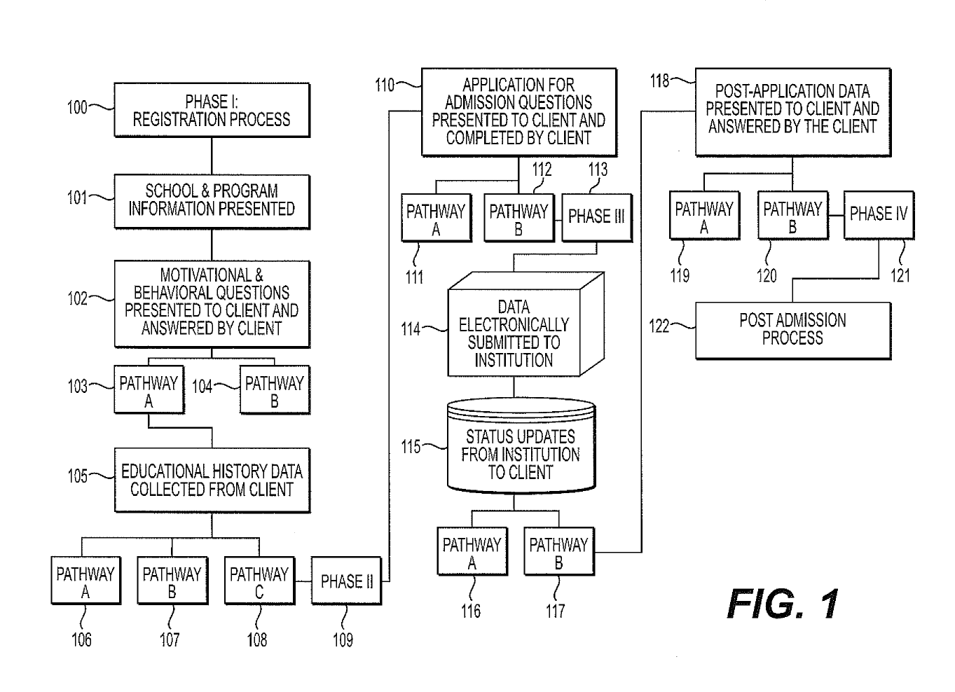

FIG. 1 is an example of how a student/user, referred to in the figure as a client, navigates the system at a relatively high level.

| | |
|---|---|
| 100 | Clients are acquired electronically in a registration |
| | process by input of individual demographic |
| | information by the client |
| 101 | A listing of school and their participating degree |
| | programs are electronically presented to clients, |
| | Clients select the school and program of inquiry. |
| | Based on the school and program selected by a |
| | client, specific data, housed at server level, is |
| | presented to client. |
| 102 | Motivational and behavioral questions are presented |
| | to client to solicit answers. Answers are stored in |
| | database for analysis. Server presents individualized, |
| | organic pathway for the client, which are |
| | determined by the client's answers to presented |
| | questions. |
| 103 | Pathway A further refines a client's educational |
| | background, electronically cross matching and |
| | comparing individual components of the client's |
| | background to the admission criterion of the |
| | institution and program previously selected by client, |
| 104 | Pathway B is a terminating pathway |
| 105 | Educational history of client gathered through a |
| | series of questions. Institution and program-specific |
| | requirements are presented to client for upload of |
| | completed documents and information. Based upon |
| | information gathered through question and answer, |
| | system analyzes data and presents individualized, |
| | organic pathways for the client. |
| 106 | Pathway A is a terminating pathway |
| 107 | Pathway B presents client with directional |
| | components, systematically guiding client to |
| | resources needed to fulfill missing requirements |
| 108 | Pathway C is presented to clients who, after |
| | systematic, logical analysis by the server, have met |
| | valid standards. Clients are provided option to |
| | continue through application phase. |
| 109 | Phase II is presented if client elects to move forward |
| | to application phase. Clients not moving forward are |
| | moved to 106. |
| 110 | Pre-established requirements, by institution and |
| | program, previously selected by client are presented |
| | in a logical, systematic rule. Questions are asked and |
| | responses gathered from client. Responses are |
| | systematically validates and pathways presented by |
| | server to client. |
| 111 | Pathway A is a terminating pathway |
| 112 | Pathway B presents client with directional |
| | components, systematically guiding client to |
| | resources needed to fulfill missing requirements |
| 113 | Phase II is presented if client elects to move forward |
| | to institution submission phase. Clients not moving |
| | forward are moved to 111. |
| 114 | Data captured through processes 100-113 is |
| | electronically pushed to institution's information |
| | system. |
| 115 | Client electronically receives institutional status |
| | updates on their application for admission into |
| | client's specific profile within invention. Once |
| | admission decision is triggered by the institution, |
| | client is presented with pathways. |
| 116 | Pathway A is a terminating pathway |
| 117 | Pathway B presents client with admission decision |
| 118 | Client moves into post-application phase and is |
| | presented with a series of pre-set question and |
| | answers relating to enrollment into the school and |
| | program previously selected by the client. Based on |
| | clients answers to questions, client is presented |
| | pathways. |
| 119 | Pathway A is a terminating pathway |
| 120 | Pathway B is presented to clients providing an option |
| | to continue through application phase. Clients |
| | opting not to move forward are moved to 119. |
| 121 | Phase IV collects enrollment intention information |
| | from the client, systematically moving client into |
| | post-application enrollment phase. |
| 122 | Clients are presented a series of post-application |
| | questions, where answers are solicited and |
| | information channeled to client through the first day |
| | of the client's program start. |

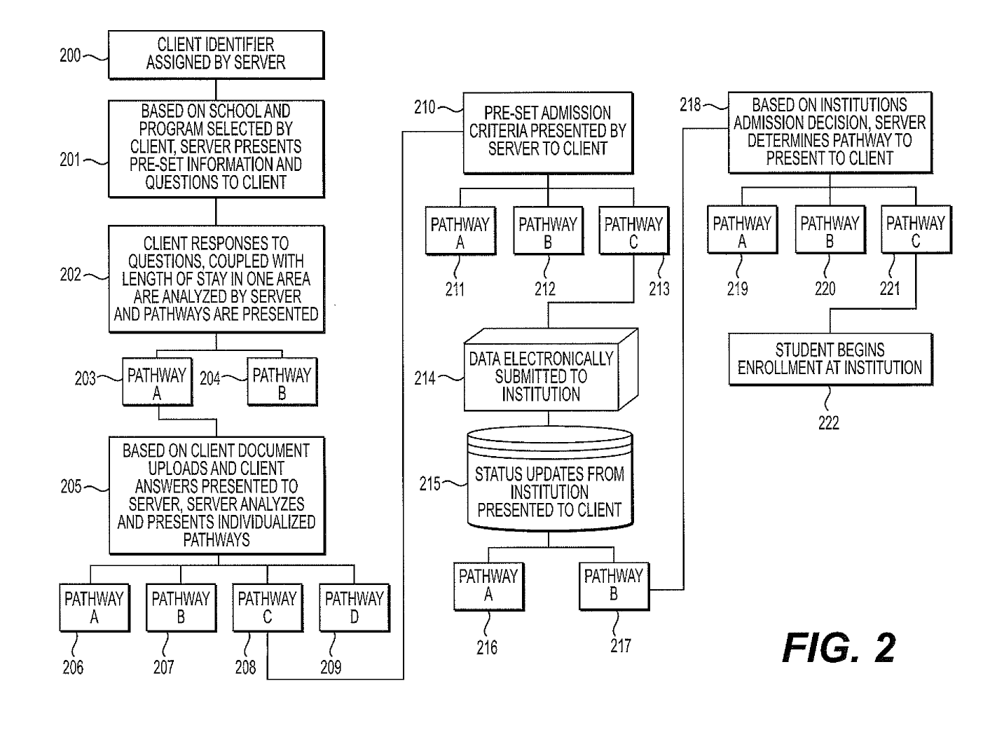

FIG. 2 illustrates how the central system server operates to facilitate the process herein. The following table provides specific explanation of FIG. 2.

| | |
|---|---|
| 200 | Server applies unique client identifier through client |
| | registration process. |
| 201 | Server is loaded with school and program-specific |
| | information including jobbing outlook, curriculum, |
| | earning potential, program descriptions, school |
| | history, and general sales and marketing |
| | information. |
| 202 | Server presents client with pre-set goals, motivation |
| | and educational history questions. Client responses |
| | are recorded on server. Through pre-determined |
| | logic and server analysis to responses, server |
| | presents individualized, organic pathways. |
| 203 | Pathway A further refines a client's educational |
| | background, electronically cross matching and |
| | comparing individual components of the client's |
| | background to the admission criterion of the |
| | institution and program previously selected by client. |
| 204 | Pathway B is a terminating pathway |
| 205 | Educational history of client gathered through a |
| | series of questions. Institution and program-specific |
| | requirements are presented to client for upload of |
| | completed documents and information. Based upon |
| | information gathered through question and answer, |
| | system analyzes data and presents individualized, |
| | organic pathways for the client. |
| 206 | Pathway A is a terminating pathway |
| 207 | Pathway B presents client with directional |
| | components, systematically guiding client to |
| | resources needed to fulfill missing requirements |
| 208 | Pathway C is presented to clients who, after |
| | systematic, logical analysis by the server, have met |
| | valid standards. Clients are provided option to |
| | continue through application phase. |
| 209 | Phase II is presented if client elects to move forward |
| | to application phase. Clients not moving forward are |
| | moved to 206. |
| 210 | System displays pre-established requirements, by |
| | institution and program in a logical, systematic rule. |
| | Questions are asked by the server and responses |
| | gathered from client. Responses are analytically |
| | validated and pathways presented by server to |
| | client. |
| 211 | Pathway A is a terminating pathway |
| 212 | Server presents pathway B with directional |
| | components, analytically guiding client to resources |
| | needed to fulfill omitted or inadequate requirements |
| 213 | Pathway C is presented by the server, soliciting |
| | client's desire to move forward to institution |
| | submission phase. Clients not moving forward are |
| | moved to 211. |
| 214 | Data captured through processes 200-213 are |
| | electronically pushed to institution's information |
| | system. |
| 215 | Through electronic push/pull methodologies, |
| | institutional status updates are presented to clients |
| | by the server in the form of bilateral pathways. |
| 216 | Pathway A is a terminating pathway |
| 217 | Pathway B presents client with admission decision |
| 218 | Client moves into post-application phase where |
| | server displays a series of pre-set question and |
| | answers relating to enrollment into the school and |
| | program. Based on clients answers to questions, |
| | server displays appropriate pathway to client. |
| 219 | Pathway A is a terminating pathway |
| 220 | Pathway B is presented to clients providing an option |
| | to continue through application phase. Clients |
| | opting not to move forward are moved to 219. |
| 221 | Server collects enrollment intention information |
| | from client, systematically moving client into post- |
| | application enrollment phase. |
| 222 | Server presented pre-determined series of post- |
| | application questions, where answers are solicited |
| | and information channeled to client by the server. |
| | Continuing this process through the first day of the |
| | client's program start. |

FIG. 3 sets forth examples of the central system server communication methods employed by the system. The following table explains the operations in FIG. 3.

| | |
|---|---|
| 300 | The database system tracks and stores data, time by |
| | unique identifier into system for each level (or |
| | screen) of activity. System calculates amount of |
| | physical time each unique user is in one area. |
| | System algorithmically calculates screen level data |
| | for each unique user, calling out to communication |
| | server to pull communication plan, which is based on |
| | a pre-determined set of communication triggers. |
| 301 | A communication database is uniquely established |
| | by institution and program with various levels and |
| | methods of communication strategies to be called |
| | and executed by server. |
| 302 | Pathway A is an email communication pathway |
| 303 | Pathway B is a messaging communication pathway |
| 304 | Pathway B is a notification communication pathway |
| 305 | Clients are presented screen-level informational |
| | communication via 302, 303, or 304. The |
| | information presented is pre-determined by the |
| | system and executed as clients reach each screen |
| | and/or phase. |
| 306 | Clients are presented institution-specific |
| | communication via 302, 303, or 304. |
| | Communication for 306 is disseminated to students |
| | at pre-set intervals, as determined by the institution |
| | and maintained by the system. |
| 307 | Motivational information is channeled to students |
| | via 302, 303, or 304. The information presented is |
| | determined by the system and is based upon client's |
| | activities (in time) for a specific screen and/or area. |
| 308 | Clients are presented screen-level informational |
| | communication via 302, 303, or 304. The |
| | information presented is determined by the system, |
| | based upon client's activities (in time) for a specific |
| | screen. |

FIG. 4 demonstrates client/user communication methods as explained in the following table.

| | |
|---|---|
| 400 | Client can initiate a communication inquiry through |
| | their individual login. Multiple pathways are |
| | presented to the client for communication |
| 401 | Frequently answered question pathways where |
| | client can search for questions and systematically be |
| | presented with answers |
| 402 | Client is able to select a button within invention to |
| | initiate a direct inbound phone call to the institution |
| | client selected. |
| 403 | Client is able to select a button within invention to |
| | execute chat texting with institution client selected. |
| 404 | Client is able to select a button within invention to |
| | execute a direct email communication with |
| | institution client selected. |
| 405 | Client is able to complete a form within invention to |
| | request a call back to them from the institution. |

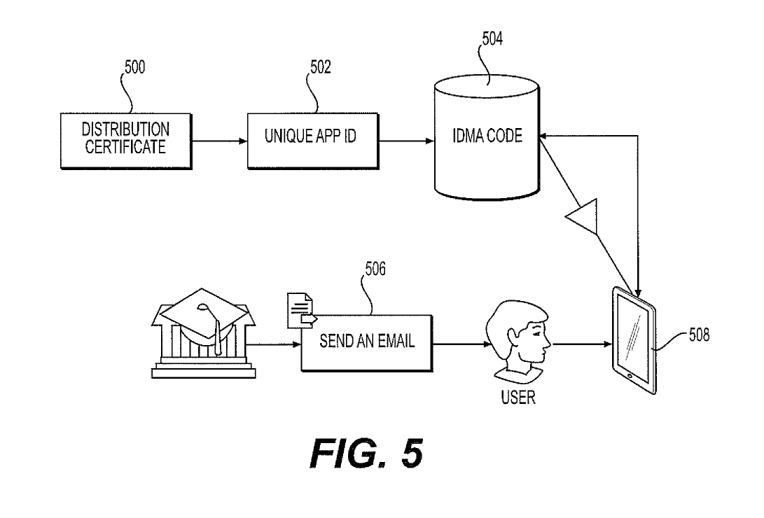

FIG. 5 illustrates how a user comes to access the system. The user is the prospective student in this example.

| | |
|---|---|
| 500 | A unique distribution certificate is obtained for the |
| | IDMA, allowing IDMA to be accessed by users |
| 502 | With the Distribution Certificate, a unique App ID is |
| | created and applied to the IDMA, allowing users to |
| | access the apparatus with their mobile device. |
| 504 | IDMA code is accessed by a user and downloaded to |
| | their mobile device for use. |
| 506 | Client communicates availability to technology to |
| | end user. |
| 508 | User access mobile device via the device's standard |
| | operating procedure |

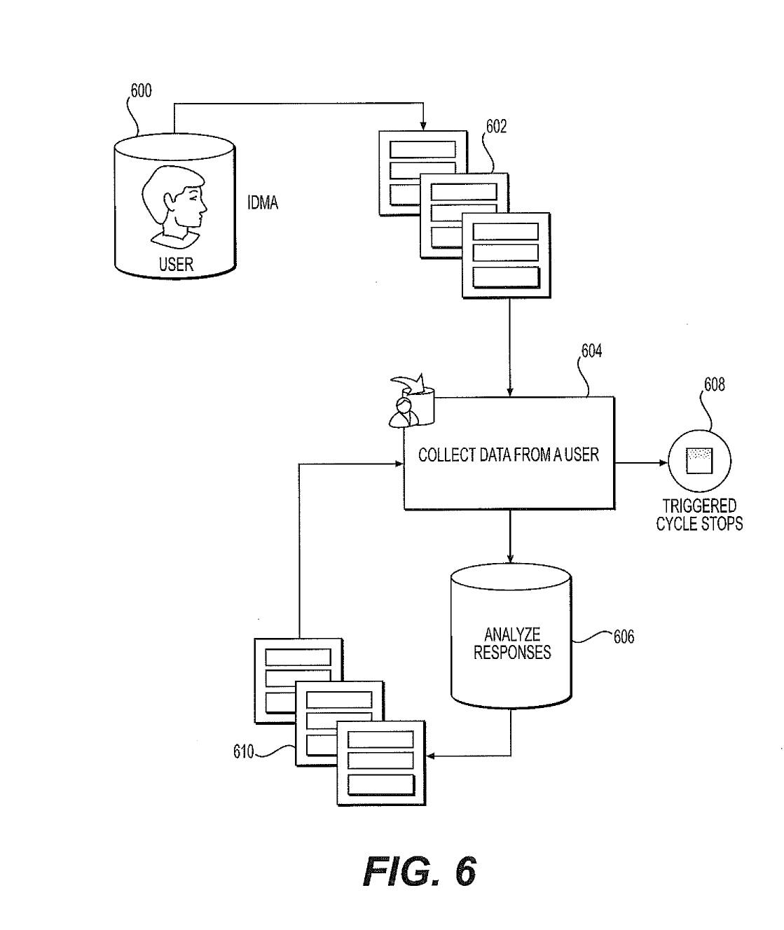

FIG. 6 illustrates the execution of the system and method described herein.

| | |
|---|---|
| 600 | Represents an end-user with IDMA executed on a |
| | local mobile device. |
| 602 | IDMA asks a series of pre-determined questions to |
| | identify user pathways |
| 604 | Data is read to and saved to server from pre- |
| | determined questions |
| 606 | IDMA analyzes responses at server end through |
| | algorithms and spatial (date/time) cross references |
| | to pre-determined pathways. |
| 608 | Triggered cycle stops are executed if answers to |
| | questions do not meet client requirements |
| 610 | Additional pathways and questions are presented to |
| | end-user, based on responses and continue to cycle |
| | back to user until user has completed process and |
| | information has been submitted to client. |

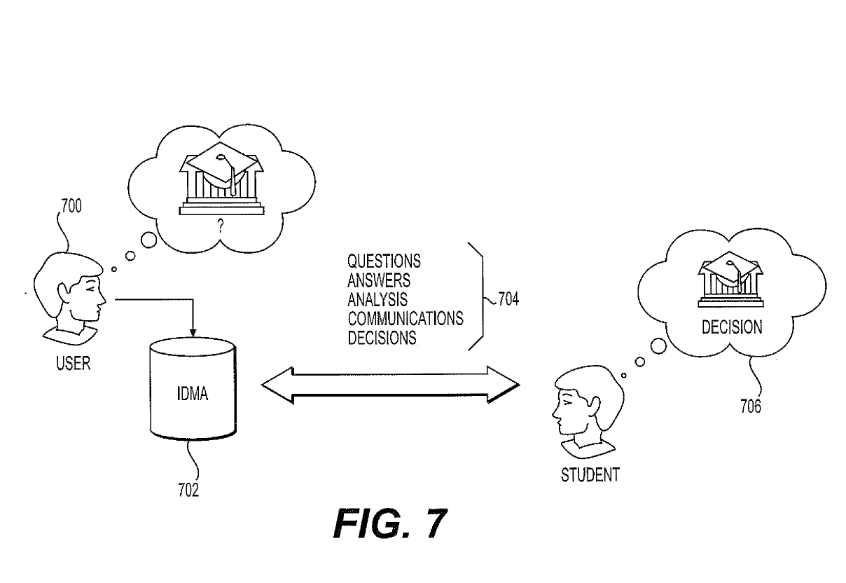

FIG. 7 illustrates the real time interactivity of the system when the user is for instance a student.

| | |
|---|---|
| 700 | Represents a user considering a post-secondary |
| | degree |
| 702 | User accesses IDMA |
| 704 | IDMA guides user through decision-making |
| | processes, provides “smart” questions to user which |
| | are based on users previous educational history, |
| | time/date spatial analysis, users goals, users |
| | motivation, and user's personal background history |
| 706 | User/Student is armed with information that is |
| | organic and unique to the user's experiences, goals, |
| | motivation. User is armed with appropriate |
| | information to make a decision on program of |
| | interest, school, and feasibility of earning a post- |
| | secondary degree |

FIG. 8 illustrates the server to IDMA (mobile application) communication structures.

| | |
|---|---|
| 800 | IDMA resides on a mobile device |
| 802 | User accesses IDMA and registers for a unique |
| | username and password. Data collected from |
| | registration process is funneled and stored at server |
| | level. Ref. 300. |
| 804 | After registration user accesses IDMA decision |
| | making model which guides the user through a series |
| | of pre-determined questions. Each question feeds |
| | back to server for analysis and determination of |
| | subsequent pathway |
| 806 | User navigates through a series of questions at |
| | multiple levels. Level 806 guides through program of |
| | interest screens. |
| 808 | User navigates through a series of questions at |
| | multiple levels. Level 808 guides through Program |
| | Outcome screens. |
| 810 | User navigates through a series of questions at |
| | multiple levels. Level 810 guides through Goals and |
| | Motivation screens. |
| 812 | User navigates through a series of questions at |
| | multiple levels. Level 812 guides through Financial |
| | Planning screens. |
| 814 | Educational History: User remains within the IDMA |
| | core model which guides the user through a series of |
| | pre-determined questions. Each question feeds back |
| | to server for analysis and determination of |
| | subsequent pathway |
| 816 | Application for Admission: User remains within the |
| | IDMA core model which guides the user through a |
| | series of pre-determined questions. Each question |
| | feeds back to server for analysis and determination |
| | of subsequent pathway |
| 818 | Post Acceptance Student Engagement: User remains |
| | within the IDMA core model which guides the user |
| | through a series of pre-determined questions. Each |
| | question feeds back to server for analysis and |
| | determination of subsequent pathway |
| 820 | Each millisecond of interaction within the IDMA is |
| | recorded back to Data Server. |
| 822 | Information gathered at the Data Server point of |
| | origin and at the School Information System point of |
| | origin is cross referenced against the pathway |
| | constructs for the IDMA. This reference is then cross |
| | matched against the student interactivity |
| 824 | Information is processed to the client/school |
| | information system at the point of application for |
| | admission submission to the institution. |
| | Subsequently, information from the client/school |
| | information system is published back to the IDMA at |
| | the student level. |
| 826 | Simultaneous to all end-user and school information |
| | system interactions within the IDMA a |
| | communication server is presenting end-users with |
| | appropriate communication. Communication is pre- |
| | defined and triggered based on the answers to pre- |
| | determined questions and the time/space evaluation |
| | of users within specific segments of the IDMA. |
| | Communication is also triggered based on feedback |
| | modules from the school information system. |

FIG. 9A is a diagram legend intended to guide reader through activities described in FIGS. 9B-F by applying intended meaning to figure shapes. FIG. 9A is believed to be self-explanatory with respect to the indicated flowchart box steps.

FIGS. 9B and 9B Cont. 1 and 2 are the workflow of an example user for School and Program, Goals and Motivation and Degree Outcome components.

| | |
|---|---|
| 900 | End user is presented with available schools and |
| | program of interest selections |
| 902 | End user selects the school they are interested in |
| | attending |
| 904 | End user selects the degree program they are |
| | interested in. The end user is presented with degree |
| | overview, including cross matches to the program |
| | requirements. This is an interactivity match with the |
| | server |
| 906 | End user is presented with degree outcomes for the |
| | degree/program they selected. |
| 908 | End user is asked question relating to the type of |
| | student, which is based on their self-reported |
| | previous educational history. The server will match |
| | the answers against the program requirements and |
| | present appropriate pathway and communication to |
| | the student. |
| 910 | End user is presented a goals and motivation |
| | segment with multiple sub screens. The responses |
| | to each of the sub screens within this section are |
| | written to the server at the end user dossier level. |
| 912 | Following the 910 sub screens, the user is navigated |
| | to this section where information is gathered to the |
| | server dossier level and additional pathways are |
| | presented based on IDMA analysis. |
| 914 | End user is presented with informational screens on |
| | the steps required to process Title IV US financial aid |
| | funding. The steps include open questions to guide |
| | through specific pathways depending on how the |
| | user answers the questions. |

FIGS. 9C and 9C Cont. are the workflow of an example user for Admission Qualification component.

| | |
|---|---|
| 916 | User is presented with a series of Admission |
| | Qualification questions |
| 917 | Based on the program of interest and institution user |
| | selected, program specific details are provided |
| 918 | User self-reports highest level of education |
| | completed, based upon inputs, data is fed to IDMA |
| | for analysis and specific pathways are presented. |
| | IDMA will perform function for user to upload |
| | document to the institution's technology system. |
| 919 | The IDMA presents secondary education questions. |
| | Depending on pathway self-selected by user, specific |
| | questions are gathered which feed to the local |
| | server and eventually to institutional server (if |
| | applicable) upon completion of process by end-user. |
| 920 | The IDMA cross matches data to program degree |
| | requirements and admission standards at server |
| | level. Depending on results of cross match various |
| | pathways are presented. |
| 921 | The IDMA runs logic to cross map |
| 922 | The IDMA cross matches data to GED minimum |
| | score requirements at server level. Depending on |
| | results of cross match various pathways are |
| | presented. IDMA will perform function for user to |
| | upload document to the institution's technology |
| | system. |
| 923 | The IDMA cross matches data to program degree |
| | requirements and admission standards at server |
| | level. Depending on results of cross match various |
| | pathways are presented. |

FIGS. 9D and 9D Cont. 1 and 2 are the workflow of an example user for Student Type component.

| | |
|---|---|
| 924 | IDMA validates Student Type information against |
| | program requirement and previously reported |
| | information, housed at server level. Based on IDMA |
| | algorithm analysis, student is guided down |
| | appropriate pathway and accurate student type is |
| | written to local server, transferred to institutional |
| | server as required. |
| 925 | IDMA recognizes if program selected is a degree |
| | completion program, if end user selects a degree |
| | completion program, they are guided down the |
| | degree completion pathway after student type is |
| | identified by IDMA |
| 926 | IDMA recognizes if program selected is a program |
| | where existing state licensures are required, if end |
| | user selects a program with this requirement, the |
| | IDMA will guide down this pathway. IDMA algorithm |
| | will define if degree completion is required in |
| | addition to licensure. |
| 927 | The IDMA will validate admission standards of the |
| | program and institution selected. Based on end user |
| | answers to these questions different pathways will |
| | be presented |
| 928 | The IDMA will validate program admission testing |
| | requirements against server information and user |
| | input data |
| 929 | If ACT test scores are validated. Based on results of |
| | IDMA analysis specific pathways are presented. |
| | IDMA will perform function for user to upload |
| | document to the institution's technology system. |
| 930 | If SAT scores are validated. Based on results of IDMA |
| | analysis, specific pathways are presented. IDMA will |
| | perform function for user to upload document to the |
| | institution's technology system. |
| 931 | TOEFL questions are presented in order to gather |
| | information at local server to identify TOEFL |
| | pathways |
| 932 | TOEFL scores entered, if required, will be cross |
| | matched to existing data at the local server level. |
| | Specific pathways will be presented to the end user |
| | by the IDMA depending on the results of the IDMA |
| | analysis. IDMA will perform function for user to |
| | upload document to the institution's technology |
| | system. |
| 933 | IDMA will gather all previous analysis from local |
| | server and validate against pre-defined admission |
| | standards at the local server level. Pathways will be |
| | presented to end user based on IDMA analysis |
| 934 | If requirements from #933 are not met, specific |
| | pathways will be presented to the end user to |
| | complete those requirements. |

FIGS. 9E and 9E Cont. 1-4 are the workflow of an example user for Application for Admission component.

| | |
|---|---|
| 935 | IDMA generates required screens based on school |
| | and program selection to facilitate user completion |
| | of an application for admission. Throughout the |
| | process user is presented with screens defining users |
| | intent to begin process of application. |
| 936 | If end user selects no for intent to continue, local |
| | server will feed “opt out” questions. |
| 937 | If end user selects to continue with application for |
| | admission, local server will feed specific |
| | program/institutional information on the application |
| | for admission relevant for the school/program |
| | selected by end user. |
| 938 | Each client will have different routing for previous |
| | applicants. Based on user responses, pathways will |
| | be presented. IDMA will perform function for user |
| | to upload document to the institution's technology |
| | system. |
| 939 | If user “opts out”, IDMA will present user with |
| | detailed information geared to the reason the user |
| | has “opted out”. This information will attempt to |
| | redirect user back into their decision making |
| | pathway. |
| 940 | IDMA will load start dates and subsequent |
| | information from server and present to user in |
| | appropriate pathway |
| 941 | IDMA will confirm for a second time the end-users |
| | intent to move forward with the processing and |
| | completion of their application for admission |
| 942 | If end user selects no for intent to continue, local |
| | server will feed “opt out” questions. If user “opts |
| | out”, IDMA will present user with detailed |
| | information geared to the reason the user has |
| | “opted out”. This information will attempt to |
| | redirect user back into their decision making |
| | pathway. |
| 943 | If end user selects yes to proceed with application, |
| | local server will present pathway of questions, |
| | These pathways of questions are specific to the |
| | program of interest end user selects and are |
| | configured based on pre-defined pathways stored at |
| | the local server. |
| 944 | IDMA will present screens to user to determine |
| | military status. |
| 945 | IDMA will present screens to user if program of |
| | interest selected requires additional documentation |
| | as part of the application for admission process. |
| | IDMA will cross match program to local server where |
| | pre-determined values will reside. |
| 946 | IDMA will determine the type of military status the |
| | end user has. Results of this determination will |
| | guide user through specific pathways. |
| 947 | IDMA will further refine the type of military status |
| | and guide user through specific pathways, which are |
| | based on this refinement. |
| 948 | IDMA will analyze end-user inputs and determine if |
| | user is eligible to receive military benefits in funding |
| | the education they have selected. If not eligible, |
| | IDMA will present user with pathways specific to |
| | civilian status. |
| 949 | If user is eligible for military educational benefits, |
| | IDMA will guide user through the process of |
| | obtaining Joint Services Transcripts. IDMA will |
| | perform function for user to upload document to the |
| | institution's technology system. |
| 950 | IDMA will validate with end user their intention to |
| | move forward and process their application for |
| | admission |
| 951 | If applicable to the school and program of interested |
| | selected by the end user, IDMA will present end user |
| | with payment screens and present function for end |
| | user to pay for either their program or their |
| | application for admission fee. |
| 952 | IDMA will gather all information from local server |
| | and feed information electronically into the |
| | institution's student information system (or other |
| | system as warranted). |
| 953 | IDMA will provide end user with engagement |
| | activities and informational activities as the user |
| | awaits the admission decision from their institution. |
| | This admission decision will be fed by the institutions |
| | technological systems into the local server, which is |
| | then fed into the IDMA for end-user access. |

FIGS. 9F and 9F Cont. are the workflow of an example user for Post Admission student engagement component.

| | |
|---|---|
| 954 | User is presented the Admission Decision section |
| | within the IDMA. Server at schools end feeds |
| | information to IDMA where student will secure |
| | information and based on a series of |
| | screen/question user will be presented appropriate |
| | pathways, which include segments 1.b-1.g |
| 955 | User is presented ability to provide enrollment |
| | intention, if the user has been successfully admitted |
| | by the school. If end user accepts admission and |
| | confirms enrollment intention, user will be |
| | presented enrollment intention information and the |
| | ability to upload their enrollment intention form |
| | which will be transferred to the Institution's |
| | technology system. |
| 956 | If user denies enrollment, post acceptance, IDMA |
| | will present a series of questions to determine |
| | reason for denial and will simultaneously present |
| | information to reengage student. |
| 957 | IDMA will gather information from local server and |
| | present instructions and functions to end user to |
| | accept or deny their admission. Local server will |
| | feed information into institution's technology |
| | system. |
| 958 | IDMA will perform function for user to upload |
| | document to the institution's technology system. |
| 959 | IDMA will present end user with processes and |
| | pathways related to completing their financial aid |
| 960 | IDMA will present end user with new student |
| | orientation either through providing information on |
| | how to access at the institutional level or through |
| | presenting the orientation within the IDMA. If |
| | presented within the IDMA pathways would be |
| | configured based on institutional requirements and |
| | will most likely vary by institution. |
| 961 | IDMA will guide end user through the process of |
| | registering for class and will interact with the |
| | institutions technology platforms. |
| 962 | IDMA will guide end user through the process of |
| | ordering books and will interact with the institutions |
| | technology platforms. |
| 963 | IDMA will provide detailed information on how to |
| | order books and where to see books for classes. |

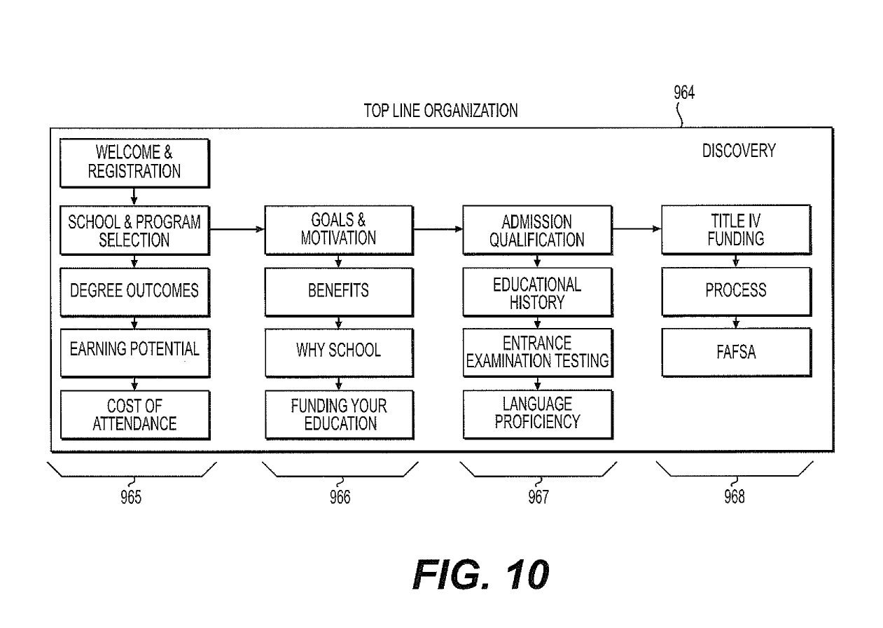

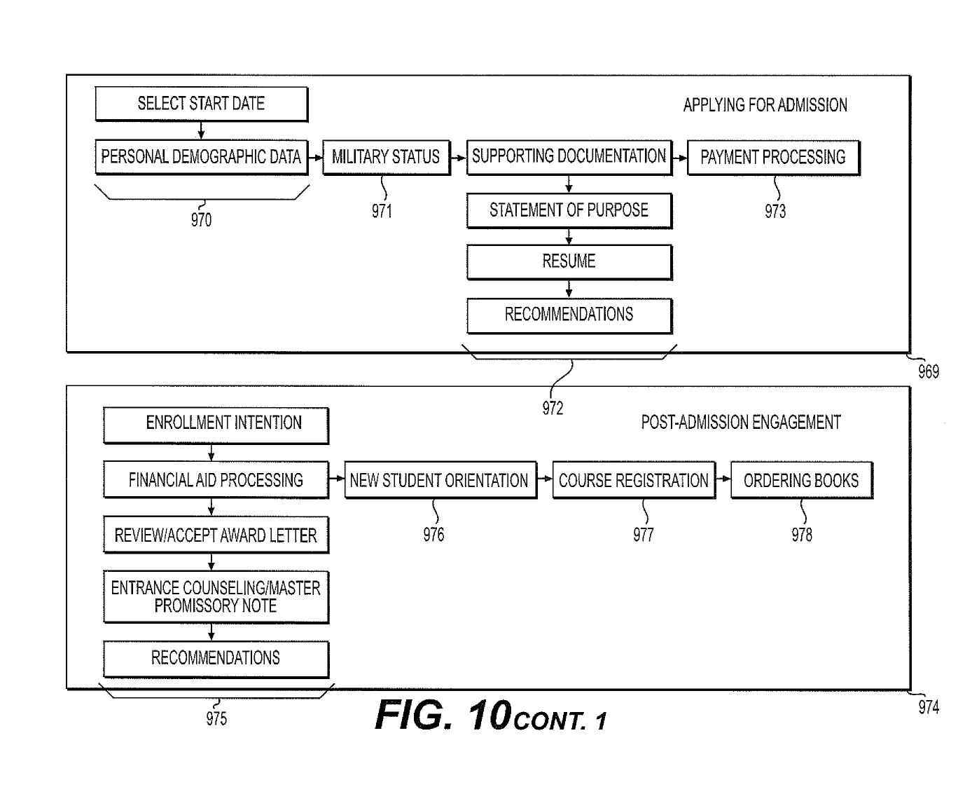

FIGS. 10 and 10 Cont.1 illustrate the top line organization of the process flow within the IDMA.

| | |
|---|---|
| 964 | The discovery section provides a series of questions |
| | and screens with information to ascertain the initial |
| | user dossier of background as well as present |
| | pathways based on user's decision making stages |
| 965 | Within discovery, the local server will present pre- |
| | defined, program and institutional informational |
| | sections to gather and store information specific to |
| | each end user. |
| 966 | Within discovery, the local server will present pre- |
| | defined student motivational and informational |
| | sections to gather and store information specific to |
| | each end user. |
| 967 | Within discovery, the local server will present |
| | program and institutional specific information on |
| | qualifications and requirements necessary for the |
| | program of interest selected. |
| 968 | Within discovery, the local server will present |
| | information on Title IV funding processes and collect |
| | information specific to each user for use during the |
| | remaining sections and pathways. |
| 969 | The Application for Admission (application process) |
| | is designed as a secondary layer to further gauge |
| | student's interest in moving forward as well as to |
| | provide client with necessary information for an |
| | admission decision to be processed. |
| 970 | Within the application section the local server will |
| | present a series of questions which are specific to |
| | the institution selected by the end user. These |
| | questions will contain pre-defined start date and |
| | personal demographic information which is then |
| | gathered and stored at the local server for use later |
| | on during the transfer to the institution. |
| 971 | Within the application section the local server will |
| | present a series of military status questions and |
| | pathway flows to determine the potential eligibility |
| | of the end user to receive military educational |
| | benefits. |
| 972 | Within the application section the local server will |
| | present a series of questions and upload procedures |
| | to the end user to gather and store at the local |
| | server level additional documentation, which is |
| | determined based on the program of interest and |
| | institution selected by the end user. Determination |
| | is pulled from pre-existing data at the local server |
| | level. |
| 973 | Within the application section the local server will |
| | provide and accept payment from the end user for |
| | either the entire program cost of the application fee |
| | associated with the school and program selected by |
| | the end user. Fees are held at the local server level |
| | and forwarded to the institution. |
| 974 | User is presented with a post-admission engagement |
| | section which is fed through the client's server as |
| | well as the local IDMA server. Questions in this |
| | section further refine the student's decision making |
| | process, engages the students in activities leading to |
| | start and allows for the institution to gather metrics |
| | in refining the analysis of those users accepted to a |
| | program that will begin the program. |
| 975 | At the post-admission engagement level the IDMA |
| | will present a series of enrollment intention, |
| | financial aid processing, financial aid award letter |
| | acceptance and supporting documentation to gather |
| | the end-user's intent in moving forward with starting |
| | their program and to prepare the end user to have |
| | all documentation required by institution. |
| 976 | At the post-admission engagement level, the IDMA |
| | will either present instructions to end user on how |
| | to complete their new student orientation at the |
| | institutional level or the IDMA will present the new |
| | student orientation directly to a student. The |
| | pathways for the New Student Orientation will vary |
| | based on institution or program of interest selected. |
| 977 | At the post-admission engagement level, the IDMA |
| | will present the ability for the end user to enroll in |
| | their courses or will present instructions for course |
| | registration/enrollment to occur at the institutional |
| | level. |
| 978 | At the post-admission engagement level, the IDMA |
| | will present the ability for the end user to order their |
| | books or will present instructions for course |
| | registration/enrollment to occur at the institutional |
| | level. |

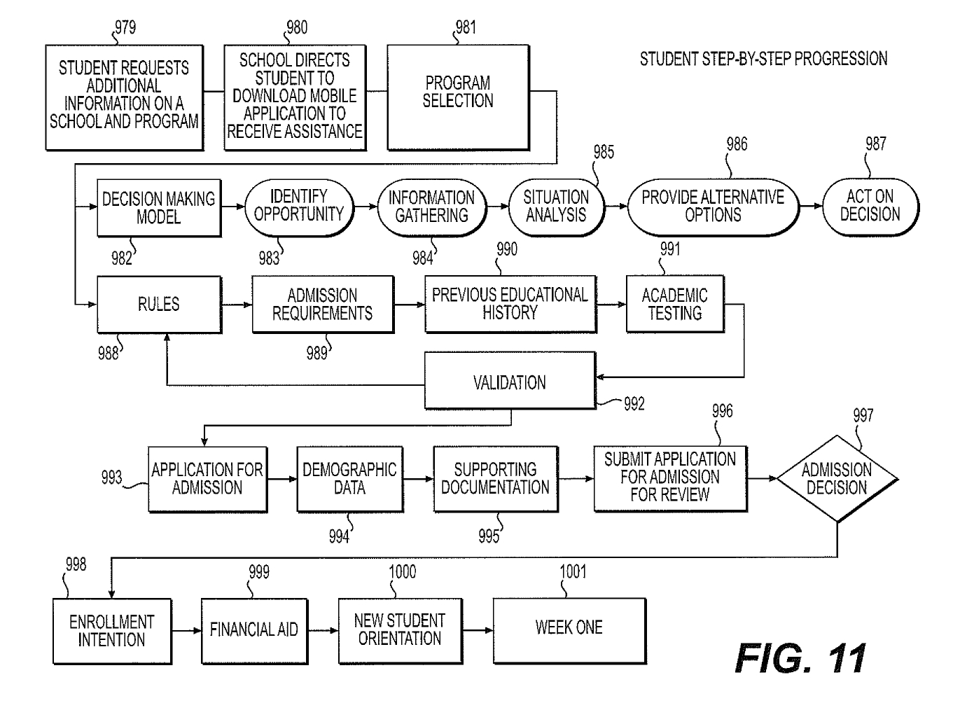

FIG. 11 illustrates a student step-by-step progression in the method and system described herein.

| | |
|---|---|
| 979 | An institution (school) will receive requests from |
| | prospective student for additional information either |
| | on the institution or on a program or both. |
| 980 | As an institution (school) receives these requests |
| | from prospective students, the prospective students |
| | are asked to download the IDMA. This |
| | communication can occur verbally, electronically, or |
| | via written format. |
| 981 | After accessing the IDMA and registering as a unique |
| | user of the IDMA, the end user will select an |
| | institution and select a degree program from a pre- |
| | determine listing of degree programs offered by the |
| | institution. |
| 982 | Following program selection, the IDMA will guide the |
| | student through a decision-making module, |
| | consisting of a series of algorithms at the local server |
| | level within the IDMA. The decision making model is |
| | intuitive and smart whereby it directs the end user |
| | down a specific pathway based on their individual |
| | needs and responses. |
| 983 | As a function of the decision making model a series |
| | of questions and responses are gathered from the |
| | end user to identify their opportunities within the |
| | institution and for the degree program selected by |
| | the end user. |
| 984 | As a function of the decision making model, |
| | information is gathered from the end user in the |
| | form of a series of question and answers. The |
| | information is stored at the local server level to be |
| | called upon during future analysis. |
| 985 | As a function of the decision making model the end |
| | user is asked to provide specific situations for |
| | analysis and direction toward specific pathways. |
| 986 | As a function of the decision making model |
| | alternative options are provided to the end user via |
| | the IDMA. Depending on the options selected by the |
| | end user, specific pathways are presented. |
| 987 | As a function of the decision making model, the |
| | IDMA will ask the end user (at multiple points) within |
| | the process to confirm and act upon their decision to |
| | engage in a post-secondary degree. |
| 988 | In addition to the decision making model, the IDMA |
| | and local server will work in conjunction with each |
| | other to provide detailed information and rules for |
| | the end users. The purpose is to engage the user, |
| | ensure program qualification for the institution and |
| | to gather information. |
| 989 | The local server will have pre-defined rules which are |
| | specific to the institution and to the programs of |
| | interest. These rules will be validated against the |
| | end-users self-reported and uploaded data and cross |
| | matched to the program requirements. |
| 990 | |
| 991 | The IDMA will present questions, per the logic at the |
| | local server for program requirement, check answers |
| | to the questions against institutional requirements |
| | for admission testing, provide upload abilities for |
| | documentation to be forwarded directly to the |
| | institution and determine end user program |
| | eligibility based on pre-admission testing |
| | requirements. |
| 992 | The IDMA will run validation checks to ensure |
| | decision making and program requirements are met |
| | at multiple levels: end user level, program level, |
| | institution level. |
| 993 | The IDMA will present the end user with multiple |
| | screens (based on institutional requirements) to |
| | secure an application for admission, upload |
| | documents required by the institution for admission |
| | decision, and process information to the institutions |
| | technology systems. |
| 994 | As part of the application for admission, |
| | demographic data will be secured and stored at the |
| | local server level. The IDMA algorithms will check |
| | date of birth, localities, etc. against requirements of |
| | the school/institution selected to ensure basic |
| | eligibility requirements are met. |
| 995 | As part of the application for admission, the IDMA |
| | will provide upload functions for all documentation |
| | requiring upload directly to the institution's |
| | technology system, this will include supporting |
| | documentation for the institution to consider the |
| | application for admission to be completed. |
| 996 | The IDMA will submit the application for admission |
| | directly to the institution's technology platform, |
| | provide communication to the institution and to the |
| | end user. |
| 997 | The institution will feed back information and |
| | communication through their technology to the |
| | IDMA (local server). |
| 998 | Based on the institutions data feed back to the local |
| | server, IDMA will process specific pathways for the |
| | student. Either a denied admission pathway or a |
| | pathway to gain end-users enrollment intention. |
| 999 | End-users within the “accepted” status for admission |
| | will be directed by the IDMA through financial aid |
| | processing at the institutional level. |
| 1000 | End-users within the “accepted” status for admission |
| | will be directed by the IDMA through new student |
| | orientation either at the IDMA level or at the |
| | institutional level |
| 1001 | At the point of the first week of classes starting |
| | students will be provided communication by the |
| | IDMA on what to expect during their first week of |
| | class along with information on various studying |
| | techniques and habits or information on how to |
| | retain within their program when obstacles occur. |

Other embodiments of the present invention will be apparent to those skilled in the art from consideration of the specification. It is intended that the specification and figures be considered as exemplary only, with a true scope and spirit of the invention being indicated by the claims.

That which is claimed is:

1. An interactive decision making system in the field of higher education enrollment comprising:
a central system server and a user electronic mobile device which are adapted to be operatively connected to each other,
wherein the central system server includes a first memory for receiving and storing program and admission information provided by an institution of higher learning, a second memory for assigning and storing an individual user identification and information, a third memory for storing a plurality of subject specific communication messages, and a fourth memory for storing questions to and answers from an individual user,
wherein the second memory further comprises a plurality of screening questions to identify user subject specific interests,
wherein the central system server also includes a spatial detector for measuring and storing spatial information including the date of use by the user of the central system server, amount of time of that use, and movement of the individual user of the user electronic mobile device on the central system server, and
wherein the central system server guides the individual user through a process of enrollment at the institution of higher education, further wherein the step of guiding includes subject specific messages from the third memory is dependent in part on the spatial information measured and stored about the individual user and is also dependent on the subject specific interests of the user saved in the second memory during the enrollment process.

2. An interactive decision making system in the field of higher education enrollment as described in claim 1, wherein the central system server further comprises a message transmitter for sending subject specific communication messages to the user.

3. An interactive decision making system in the field of higher education enrollment as described in claim 2, wherein the subject specific communication messages are sent via multiple levels of communication that vary depending on the spatial information stored with respect to the individual user movement on the central server system.

4. An interactive decision making system in the field of higher education enrollment as described in claim 3, wherein the levels of communication are selected from the group consisting of notifications, reminders, messaging, emails, inbound call routing, chat services, and form and content display.

5. An interactive decision making system in the field of higher education enrollment as described in claim 3, wherein the subject specific communication messages include content from the first memory, third party content and institutional deadlines.

6. An interactive decision making system in the field of higher education enrollment as described in claim 3, wherein the level of communication depends on an institution of higher learning, type of academic program, and user educational history.

7. An interactive decision making system in the field of higher education enrollment as described in claim 1, wherein the central system server matches user subject specific interests to a higher education institutional server.

8. A method for managing information and enrollment in the field of higher education comprising the steps of:
providing a central system server and a user mobile device which are adapted to be operatively connected to each other,
wherein the central system server includes a first memory for receiving and storing program and admission information provided by an institution of higher learning, a second memory for assigning and storing an individual user identification and information including a plurality of screening questions to identify user subject specific interests, a third memory for storing a plurality of subject specific communication messages, and a fourth memory for storing questions to and answers from a user, and
wherein the central system server also includes a spatial detector for measuring and storing spatial information including the date of use by the user of the central system server, amount of time of that use, and movement of the individual user of the user electronic mobile device on the central system server,
assigning to the user by the central system server a unique user identification,
prompting program and admission screening questions by the central system server to the user to identify user subject specific interests,
storing answers to the program and admission screening questions by the central system server,
detecting the spatial information of the individual user and storing the spatial information associated with the unique user identification,
selecting individual pathways of communication by the central system server to the user based on the stored spatial information of the user and stored answers by the user to the user subject specific interests questions from the central system server,
whereby the process of enrollment by a user is customized to the user based on the spatial information and screening question answers of the individual.

9. A method for managing information and enrollment in the field of higher education as described in claim 8, wherein the central system server further comprises a message transmitter for sending subject specific communication messages to the user.

10. A method for managing information and enrollment in the field of higher education as described in claim 9, wherein the subject specific communication messages are sent via multiple levels of communication that vary depending on the spatial information stored with respect to the individual user movement on the central server system.

11. A method for managing information and enrollment in the field of higher education as described in claim 10, wherein the levels of communication are selected from the group consisting of notifications, reminders, messaging, emails, inbound call routing, chat services, and form and content display.

12. A method for managing information and enrollment in the field of higher education as described in claim 9, wherein the subject specific communication messages include content from the first memory, third party content and institutional deadlines.

13. A method for managing information and enrollment in the field of higher education as described in claim 10, wherein the level of communication depends on an institution of higher learning, type of academic program, and user educational history.

14. A method for managing information and enrollment in the field of higher education as described in claim 9, wherein the central system server matches user subject specific interests to a higher education institutional server.
